(19) United States
(12) Patent Application Publication
(10) Pub. No.: US 2013/0330550 A1
(43) Pub. Date: Dec. 12, 2013

(54) ANCHOR-LAYER-FORMING COATING LIQUID, PRESSURE-SENSITIVE ADHESIVE LAYER-CARRYING OPTICAL FILM AND METHOD FOR PRODUCING THE FILM

(71) Applicant: NITTO DENKO CORPORATION, Osaka (JP)

(72) Inventors: Yuusuke Toyama, Ibaraki-shi (JP); Tomoyuki Kimura, Ibaraki-shi (JP); Masakuni Fujita, Ibaraki-shi (JP)

(21) Appl. No.: 13/910,605

(22) Filed: Jun. 5, 2013

(30) Foreign Application Priority Data
Jun. 8, 2012 (JP) 2012-131023

(51) Int. Cl. C09D 141/00; C09J 7/02

(52) U.S. Cl. CPC C09D 141/00; C09J 7/0207
USPC 428/355 R; 428/419; 427/162; 525/206; 525/127

(57) ABSTRACT

A coating liquid for forming an anchor layer interposed between an optical film and a pressure-sensitive adhesive layer, comprising a polythiophene based polymer, a polyoxyalkylene-group-containing polymer, and a mixed solvent comprising 65 to 100% by weight of water and 0 to 35% by weight of an alcohol.

### BACKGROUND OF THE INVENTION

1. Field of the Invention

The present invention relates to a coating liquid for forming an anchor layer interposed between an optical film and a pressure-sensitive adhesive layer, a pressure-sensitive adhesive layer-carrying optical film, and a method for producing thereof. Examples of the optical film include a polarizing film, a retardation plate, an optical compensation film, a brightness enhancement film, a reflection reducing film, any other surface-treating film, and any laminate in which two or more thereof are laminated onto each other.

2. Description of the Related Art

In a liquid crystal display device, for example, it is indispensable to arrange polarizing elements on both sides of its liquid crystal cell, respectively. Generally, in the liquid crystal display device, or an organic electro-luminescent (EL) display device or some other display device, in light of an image forming manner thereof, a polarizing film is bonded thereto as such a polarizing element. In display panels such as liquid crystal panels and organic EL panels, various optical elements have been used besides a polarizing film to improve the display quality of their displays. In image display devices such as a liquid crystal display device, an organic EL display device, a CRT and a PDP, a front plate has been used to protect the display devices, give a high-class impression thereto, and discriminate a design thereof from other designs. In such image display devices, such as a liquid crystal display device and an organic EL display device, and members used together with the image display devices, such as a front plate, a surface-treating film is used, examples thereof including a retardation plate for preventing coloration, a viewing angle enlargement film for improving the viewing angle of the liquid crystal display, a brightness enhancement film for enhancing contrast on their display, a hard coat film used to give a scratch resistance onto their surface, an antiglare treatment film for preventing a surrounding image from being projected onto the image display devices, and a reflection reducing film such as an antireflective film or a low reflective film. These films are collectively named optical films.

When such an optical film is bonded onto a display panel such as a liquid crystal cell and organic EL panel, or onto a front plate thereof, a pressure-sensitive adhesive is usually used. About bonding between an optical film, and a display panel such as a liquid crystal cell or organic EL panel, a front plate, or an optical film, usually, a pressure-sensitive adhesive is used to cause the individual members to be bonded to adhere closely onto each other to decrease light loss. In such cases, a pressure-sensitive adhesive layer-carrying optical film, in which a pressure-sensitive adhesive layer is beforehand provided on a single side surface of an optical film, is generally used since the pressure-sensitive adhesive layer-carrying optical film has an advantage that no drying step is required for bonding and fixing the optical film, and the like.

An optical film is easily shrunken or expanded when heated or humidified. Thus, when the adhesion between an optical film and a pressure-sensitive adhesive thereon is low, the optical film and the pressure-sensitive adhesive layer may be partially separated or peeled from each other. When a liquid crystal panel is used, particularly, for a car navigation system or any other article to be mounted onto an automobile, which requires the panel to have a higher endurance, a large shrinkage stress is applied onto the optical film (of the liquid crystal panel). Thus, the separation or peel is more easily caused. Specifically, although an optical film causes no problem in a reliability test carried out at about 80° C. for, for example, TVs, the film easily causes an inconvenience such as a separation or peel as described above in a reliability test carried out at about 95° C. for car navigation systems or any other article to be mounted onto an automobile. Ina case where after a pressure-sensitive adhesive layer-carrying optical film is bonded onto a liquid crystal display, the film is once peeled as needed and then the film is again bonded (or reworked) thereto, the following inconvenience is caused, that is, when the adhesive force between the optical film and the pressure-sensitive adhesive is low, the pressure-sensitive adhesive unfavorably remains on the surface of the liquid crystal display device so that the rework is not efficiently attained. When a pressure-sensitive adhesive layer-carrying optical film is handled in the step of cutting the film, carrying the film, or the like, an edge region of this film may contact a person or an article around the film. In this case, the pressure-sensitive adhesive may be removed in this region so that the liquid crystal panel easily undergoes an inconvenience such as display failure. In order to overcome such inconveniences, a method is carried out in which an anchor layer is applied onto an optical film and then a pressure-sensitive adhesive is applied thereonto to improve the adhesion between the optical film and the pressure-sensitive adhesive layer.

In the meantime, a pressure-sensitive adhesive layer as described above is required not to cause any inconvenience resulting from this pressure-sensitive adhesive layer when an article with the pressure-sensitive adhesive layer is subjected to a heating and humidifying endurance test, which is usually done as an environment acceleration test. However, when an anchor layer is interposed between an optical film and a pressure-sensitive adhesive layer, a problem is caused that in an endurance test, a solvent crack is generated on the anchor-layer-formed side surface of the optical film. Even when no solvent crack is generated in a reliability test carried out at about 80° C. for, for example, TVs, a solvent crack may be remarkably generated, particularly, in a reliability test carried out at about 95° C. for car navigation systems or any other article to be mounted onto an automobile.

Patent Document 1 describes a pressure-sensitive adhesive layer-carrying optical film in which an anchor layer is interposed between an optical film and a pressure-sensitive adhesive layer, and the anchor layer is obtained by coating/drying an anchor-layer-forming coating liquid containing a mixed solvent of water and an alcohol, and a polyamine compound. However, for this pressure-sensitive adhesive layer-carrying optical film, no investigation is concretely made about the composition of the anchor-layer-forming coating liquid, and conditions for drying the liquid in order to solve the problem that a solvent crack is generated on the anchor-layer-formed side surface of the optical film in an endurance test.

Patent Document 2 describes a pressure-sensitive adhesive layer-carrying optical film in which an anchor layer is interposed between an optical film and a pressure-sensitive adhesive layer, and the anchor layer is obtained by coating/drying an anchor-layer-forming coating liquid containing a mixed solvent of water and an alcohol, and an oxazoline group-containing polymer, and specifically discloses an example in which about conditions for drying this anchor-layer-forming coating liquid, the drying temperature and the drying period are set to 40 degrees and 120 seconds, respectively. Furthermore, Patent Document 3 describes a pressure-sensitive adhesive layer-carrying optical film in which an anchor layer is interposed between an optical film and a pressure-sensitive adhesive layer, and the anchor layer is obtained by coating/drying an anchor-layer-forming coating liquid made of an aqueous solution containing a polyurethane resin and a water-soluble polythiophene based electroconductive polymer, and specifically discloses an example in which about conditions for drying this anchor-layer-forming coating liquid, the drying temperature and the drying period are set to 80 degrees and 120 seconds, respectively. However, it has been made evident that under these drying conditions, there remains a room for making a further improvement from the viewpoint of preventing the generation of the above-mentioned solvent crack.

Patent Document 4 describes a pressure-sensitive adhesive layer-carrying optical film in which an anchor layer is interposed between an optical film and a pressure-sensitive adhesive layer, and the anchor layer is obtained by coating/drying an anchor-layer-forming coating liquid containing ammonia and a water-dispersible polymer, and specifically discloses an example in which about conditions for drying this anchor-layer-forming coating liquid, the drying temperature and the drying period are set to 50 degrees and 60 seconds, respectively. However, when the proportion of ammonia present in the anchor layer becomes large, the following is caused: in the case of using, for example, a polarizing film as the optical film in a high temperature and high humidity environment, the polarizing property of the polarizing film is varied. This variation affects the optical property so that the film may be unable to come to satisfy a high endurance in the high temperature and high humidity environment.

As described above, in the prior art, no attention has been paid to the problem that a solvent crack is generated on an anchor-layer-formed side surface of an optical film. Thus, in order to overcome this problem, a further investigation has been required.
[Patent Document 1] JP-A-2004-078143
[Patent Document 2] JP-A-2007-171892
[Patent Document 3] JP-A-2009-242786
[Patent Document 4] JP-A-2007-248485

### SUMMARY OF THE INVENTION

Recently, in a liquid crystal panel in an IPS mode or the like, the surface of the panel has been usually subjected to, for example, ITO treatment for an antistatic measure. However, by effect of a decrease in costs and others, an ITO treatment or the like which is inexpensive to be poor in performance may be used. Thus, a polarizing film to be bonded thereto is desired to be further improved in electroconductivity. Meanwhile, about liquid crystal panels, an enhancement thereof in brightness and contrast has been advanced for use particularly in a large TV and others. With the enhancement, a polarizing film is also required to have a high transmittance and a high polarizing degree. Thus, importance has been attached to the restraint of a reduction in the transmittance that results from its individual constituent members including its anchor layer.

In a polarizing film, the electroconductivity of its anchor layer can be improved by increasing the amount of a conductant added into the anchor layer. However, when the addition amount of the conductant is increased, the transmittance of the anchor layer is inevitably largely reduced. In other words, in the actual circumference, antinomy relationship exists between an improvement in the electroconductivity of the anchor layer and the restraint of a reduction thereof in transmittance.

In light of the actual circumferences, the present invention has been made, and an object thereof is to provide an anchor-layer-forming coating liquid capable of forming an anchor layer that is interposed between an optical film and a pressure-sensitive adhesive layer and is excellent in electroconductivity and wettability to the optical film.

Another object of the present invention is to provide a pressure-sensitive adhesive layer-carrying optical film having an anchor layer wherein the anchor layer is excellent in electroconductivity and in wettability to the optical film, and a transmittance reduction shown by the anchor layer alone can be restrained; and a method for producing the optical film.

In order to solve the problems, the inventors have made eager investigations to find out that by use of an anchor-layer-forming coating liquid to form an anchor layer over at least one surface of an optical film, a pressure-sensitive adhesive layer-carrying optical film can be produced wherein the optical film and the anchor layer are excellent to wettability on each other, and a transmittance reduction by the anchor layer alone can be restrained, the anchor-layer-forming coating liquid being obtained by adding a polythiophene based polymer and a polyoxyalkylene-group-containing polymer to a mixed solvent containing water and an alcohol, particularly, a mixed solvent containing water as a main component. From results of the investigations, the present invention has been made. The present invention, which attains the above-mentioned objects, is as follows:

Thus, the present invention relates to a coating liquid for forming an anchor layer interposed between an optical film and a pressure-sensitive adhesive layer, comprising a polythiophene based polymer, a polyoxyalkylene-group-containing polymer, and a mixed solvent comprising 65 to 100% by weight of water and 0 to 35% by weight of an alcohol.

Preferably, the anchor-layer-forming coating liquid further includes a polyurethane resin based binder.

In the anchor-layer-forming coating liquid, it is preferred that the polythiophene based polymer is comprised in a proportion of 0.005 to 5% by weight, the polyoxyalkylene-group-containing polymer in a proportion of 0.005 to 5% by weight, and the polyurethane resin based binder in a proportion of 0.005 to 5% by weight.

The present invention also relates to a pressure-sensitive adhesive layer-carrying optical film with a pressure-sensitive adhesive layer laminated over at least one surface of the optical film with an anchor layer interposed therebetween, wherein the anchor layer is a layer obtained by coating and drying the anchor-layer-forming coating liquid according to claim 1 over the optical film, and the anchor layer alone shows a transmittance reduction of 1% or less.

In the pressure-sensitive adhesive layer-carrying optical film, it is preferred that the optical film is a film obtained by subjecting an anchor-layer-formed-side surface of the film to an adhesion facilitating treatment.

In the pressure-sensitive adhesive layer-carrying optical film, it is preferred that the anchor-layer-formed-side surface of the optical film comprises unsaponified triacetylcellulose.

The pressure-sensitive adhesive layer-carrying optical film is preferably a pressure-sensitive adhesive layer-carrying polarizing film.

The present invention also relates to a method for producing a pressure-sensitive adhesive layer-carrying optical film with a pressure-sensitive adhesive layer laminated over at least one surface of the optical film with an anchor layer interposed therebetween, comprising, before the step of forming the anchor layer, at least, an adhesion facilitating treatment step of subjecting the anchor-layer-formed side surface of the optical film to an adhesion facilitating treatment, and an application step of applying the anchor-layer-forming coating liquid according to claim 1 onto the easy adhesion treatment surface of the optical film, wherein the anchor layer alone shows a transmittance reduction of 1% or less.

In the method for producing the pressure-sensitive adhesive layer-carrying optical film, it is preferred that the anchor-layer-formed-side surface of the optical film includes unsaponified triacetylcellulose.

In the method for producing the pressure-sensitive adhesive layer-carrying optical film, it is preferred that the application step is followed by an anchor layer forming step comprising drying the coating liquid under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

In the method for producing the pressure-sensitive adhesive layer-carrying optical film, it is preferred that there is a time period of at most 30 seconds between applying the anchor layer-forming coating liquid to the optical film and starting the drying.

The image display device according to the present invention is a device wherein the above-mentioned polarizing film or optical film is used.

### Advantageous Effects of the Invention

In the anchor-layer-forming coating liquid according to the present invention, the polythiophene based polymer, which acts as a conductant, is present in the mixed solvent being rich in water (the alcohol content ≦35% by weight); thus, the polythiophene based polymer is improved in dispersibility. For this reason, an improvement is made in the electroconductivity of an anchor layer obtained by coating/drying the anchor-layer-forming coating liquid.

When the mixed solvent in the anchor-layer-forming coating liquid is made rich in water, it is feared that the wettability thereof onto an optical film is deteriorated to decline the paintability of this coating liquid. However, the anchor-layer-forming coating liquid according to the present invention contains the polyoxyalkylene-group-containing polymer while the mixed solvent is made rich in water. It is therefore possible to improve, with a good balance, both of the electroconductivity of the anchor layer obtained by coating/drying this coating liquid, and the wettability between the anchor layer and the optical film.

When the anchor-layer-forming coating liquid according to the present invention includes, as a binder component, a polyurethane resin binder, the adhesion is improved between the optical film and the pressure-sensitive adhesive layer through the anchor layer obtained from this coating liquid and therefore it is preferable.

In the pressure-sensitive adhesive layer-carrying optical film according to the present invention, the anchor-layer-forming coating liquid, which is a raw material thereof, is rich in water. It is therefore possible to improve the electroconductivity of the anchor layer while the content by percentage of the polythiophene based polymer in the anchor layer is reduced, and further restrain a transmittance reduction shown by the anchor layer alone with the reduction in the content by percentage of the polymer component. Additionally, since the anchor-layer-forming coating liquid contains the polyoxyalkylene-group-containing polymer, wettability is excellent between the optical film and the anchor layer.

Generally, in the case of subjecting an optical film to a step for an adhesion facilitating treatment and subsequently forming an anchor layer thereon in order to heighten the adhesion of the optical film onto a pressure-sensitive adhesive layer, oxalic acid and others are generated over the optical film by the adhesion facilitating treatment and the pH value thereof is lowered. As a result, a binder resin component in a coating liquid for forming the anchor layer is declined in liquid stability, so that contaminants may be generated which originates from the binder resin. However, in the pressure-sensitive adhesive layer-carrying optical film according to the present invention, by enriching the water content (the alcohol content ≦35% by weight) in the mixed solvent of the anchor-layer-forming coating liquid, which is a raw material of the film, the liquid stability of the binder component can be maintained even when the pH value of the binder component is lowered. As a result, the generation of contaminants can be restrained which originates from the binder, so that in the pressure-sensitive adhesive layer-carrying optical film having the anchor layer, the production amount of contaminants in the anchor layer can be restrained.

In the pressure-sensitive adhesive layer-carrying optical film according to the present invention, particularly, in a case of a coating liquid for forming its anchor layer containing a polyurethane resin binder as a binder resin component, an improvement is made in adhesion between the optical film and the pressure-sensitive adhesive layer through the resultant anchor layer and therefore it is preferable. In the other hand, the use of the polyurethane resin binder more easily causes the generation of contaminants by effect of oxalic acid generated over the optical film by an adhesion facilitating treatment. The reason therefor is unclear. However, the reason would be as follows: the generation or existence of an acid such as oxalic acid makes the pH value of the binder low; and with the lowering in the pH value, the liquid stability of the binder intensely tends to be deteriorated since a urethane binder tends to be made stable by weak alkalinity. In the case of using, as the polyurethane resin binder, particularly a water-soluble or water-dispersible polyurethane resin binder, the production amount of contaminants tends to be remarkably increased by the lowering in the pH value. In the present invention, however, even in the case that a polyurethane resin binder, particularly, a water-soluble or water-dispersible polyurethane resin binder is used, the liquid stability thereof can be maintained by making the mixed solvent in the anchor-layer-forming coating liquid rich in water even when the pH value of the binder component is lowered. As a result, the generation of contaminants can be restrained in the anchor layer.

Furthermore, when the anchor-layer-formed side surface of the optical film includes an unsaponified triacetylcellulose, the generation amount of oxalic acid is increased so that contaminants are in particular easily generated. However, in the present invention, since an anchor-layer-forming coating liquid having a specific mixed solvent ratio is used, the generation of contaminants can be more effectively restrained.

In the present invention, the anchor-layer-forming coating liquid, which includes a mixed solvent containing water and an alcohol as main components, is dried under drying conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

### DETAILED DESCRIPTION OF THE PREFERRED EMBODIMENTS

The present invention relates to a coating liquid for forming an anchor layer interposed between an optical film and a pressure-sensitive adhesive layer, including a polythiophene based polymer, a polyoxyalkylene-group-containing polymer, and a mixed solvent containing 65 to 100% by weight of water and 0 to 35% by weight of an alcohol.

The alcohol is preferably hydrophilic at normal temperature (25° C.), and in particular, miscible with water at an arbitrary ratio. The alcohol is preferably an alcohol having 1 to 6 carbon atoms, more preferably an alcohol having 1 to 4 carbon atoms, even more preferably an alcohol having 1 to 3 carbon atoms. Specific examples of the alcohol include methanol, ethanol, n-propanol, isopropyl alcohol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol. Of these examples, ethanol and isopropyl alcohol are preferred, and isopropyl alcohol is more preferred. The alcohols may be used alone or in the form of a mixture of two or more thereof. The two or more alcohols may be mixed with each other at an arbitrary ratio. For example, a mixed alcohol may be used which is obtained by mixing ethanol and isopropanol at an arbitrary ratio.

Various forms of the polythiophene based polymer may be used. A water-soluble or water dispersible polymer can be suitably used. The weight-average molecular weight of the polythiophene based polymer is preferably 400000 or less, more preferably 300000 or less in terms of that of polystyrene. If the weight-average molecular weight is more than the upper value, the polymer tends not to satisfy the water-solubility or water-dispersibility. When such a polymer is used to prepare a coating liquid, a solid of the polymer tends to remain in the coating liquid, or the polymer tends to be increased in viscosity so that an anchor layer with even film thickness is hard to be formed.

The word “water-soluble” or “water-solubility” denotes that the solubility of any compound in 100 g of water is 5 g or more. The solubility of the water-soluble polythiophene based polymer in 100 g of water is preferably from 20 to 30 g. The polythiophene based polymer that is water-dispersible is a polymer that is dispersible in water in the state that the polymer is in the form of fine particles. A water-dispersible liquid is small in liquid viscosity to be easily used for thin film coating, and further the resultant painted layer is excellent in evenness. The size of the fine particles is preferably 1 μm or less from the viewpoint of the evenness of the anchor layer.

The water-soluble or water-dispersible polythiophene based polymer preferably has, in the molecule thereof, a hydrophilic functional group. Examples of the hydrophilic functional group include a sulfonic group, an amino group, an amide group, an imino group, a quaternary ammonium salt, a hydroxyl group, a mercapto group, a hydrazino group, a carboxyl group, a sulfate group, and a phosphate group; and salts of these groups. When the polymer has in the molecule a hydrophilic functional group, the polymer is easily soluble in water, or is easily dispersible, in the form of fine particles, in water. Thus, the water-soluble or water-dispersible polythiophene based polymer can easily be prepared.

Examples of the water-soluble or water-dispersible polythiophene based polymer include DENATRON series polymers manufactured by Nagase ChemteX Corp.

When the ratio between water to the alcohol in the mixed solvent is set to the above-mentioned ratio and further the polythiophene based polymer, which has electroconductivity, is used as a binder component, the polythiophene based polymer is made higher in dispersibility in the anchor-layer-forming coating liquid. As a result, an anchor layer obtained by coating/drying the anchor-layer-forming coating liquid is further improved in electroconductivity. When the ratio between water to the alcohol in the mixed solvent is set to the above-mentioned ratio, the liquid stability of the binder can be maintained even if the pH of the binder component is lowered. Thus, the generation of contaminants can be restrained in the anchor layer. Additionally, when the water-rich mixed solvent is used, the anchor layer can be more efficiently prevented from undergoing a solvent crack. From the viewpoint of improving the anchor layer, particularly, in electroconductivity, it is preferred to use a mixed solvent containing 80 to 100% by weight of water and 0 to 20% by weight of an alcohol.

From the viewpoint of improving the anchor layer in electroconductivity, the content of the polythiophene based polymer in the anchor-layer-forming coating liquid is preferably from 0.005 to 5% by weight, more preferably from 0.01 to 3% by weight, even more preferably from 0.01 to 1% by weight, most preferably from 0.01 to 0.5% by weight.

In the present invention, the anchor-layer-forming coating liquid contains a polyoxyalkylene-group-containing polymer together with the mixed solvent and the polythiophene based polymer. The polyoxyalkylene-group-containing polymer is, for example, a polyoxyalkylene-group-containing poly(meth)acrylate having a poly(meth)acrylate polymer as a main chain and having a polyoxyalkylene group, such as a polyoxyethylene group or a polyoxypropylene group, in a side chain. When the wettability of the anchor layer onto an optical film is considered, the content of the polyoxyalkylene-group-containing polymer in the anchor-layer-forming coating liquid is preferably from 0.005 to 5% by weight, more preferably from 0.01 to 3% by weight, even more preferably from 0.01 to 1% by weight, most preferably from 0.01 to 0.5% by weight.

In addition to the polythiophene based polymer and the polyoxyalkylene-group-containing polymer, a binder component may be incorporated into the anchor-layer-forming coating liquid according to the present invention to improve the anchor layer in anchoring performance, and improve the adhesion between an optical film and a pressure-sensitive adhesive layer. For improving the anchoring power of the pressure-sensitive adhesive, any resin (polymer) having an organic reactive group such as a polyurethane resin based binder such as a water-soluble or water-dispersible polyurethane resin based binder, an epoxy resin based binder, an isocyanate resin based binder, a polyester resin based binder, a polymer having in the molecule thereof an amino group, and a binder of an acrylic resin that may be of various types and contains, for example, an oxazoline group may be used as the binder component. When the coating liquid contains, particularly, a polyurethane resin based binder as the binder component, the adhesion between an optical film and a pressure-sensitive adhesive layer can be improved through an anchor layer obtained from the anchor-layer-forming coating liquid and therefore it is preferable. The content of the binder resin in the anchor-layer-forming coating liquid is preferably from 0.005 to 5% by weight, more preferably from 0.01 to 3% by weight, even more preferably from 0.01 to 1% by weight, most preferably from 0.01 to 0.5% by weight.

In the case of using the polyurethane resin based binder, such as a water-soluble or water-dispersible polyurethane resin based binder, an improvement is made, particularly, in the adhesion between an optical film and a pressure-sensitive adhesive layer and therefore it is preferable. Meanwhile, the use of the polyurethane resin based binder tends to increase the generation amount of contaminants resulting from the polyurethane resin when the pH value of the anchor-layer-forming coating liquid is lowered by, for example, the generation of oxalic acid. In the present invention, however, the production amount of contaminants can be restrained by setting, into the specific range, the ratio of water to the alcohol in the mixed solvent of the anchor-layer-forming coating liquid.

In the anchor-layer-forming coating liquid, an increase in the proportion of a component other than water and the alcohol, for example, ammonia may cause the following: when a polarizing film is used as the optical film in a high-temperature and high-humidity environment, the polarizing property of the polarizing film is varied, and the variation may affect the optical property so that the polarizing film becomes unable to satisfy a high endurance in the high-temperature and high-humidity environment. It is therefore preferred that the mixed solvent (solvent for diluting the binder resin) in the anchor-layer-forming coating liquid contains, as main components thereof, water and the alcohol, specifically, the total amount of water and the alcohol is 90% or more by weight in the mixed solvent. This total amount is more preferably 95% by weight or more, even more preferably 99% by weight or more, most preferably substantially 100% by weight.

When the anchor-layer-forming coating liquid contains ammonia, the painted-coat external appearance and the optical reliability of the anchor layer may be excellent in some cases. However, the content of ammonia is preferably as small as possible from the viewpoint of the endurance and the prevention of a solvent crack. Specifically, the ammonia content in the anchor-layer-forming coating liquid is preferably less than 0.05 part by weight, more preferably less than 0.03 part by weight for 100 parts by weight of the binder resin(solid content).

An additive may be blended into the anchor-layer-forming coating liquid if necessary. Examples of the additive include a leveling agent, an antifoaming agent, a thickener, and an antioxidant. Of these additives, preferred is a leveling agent (for example, one having an acetylene skeleton). The ratio of the additive(s) is preferably from about 0.01 to 500 parts by weight, more preferably from 0.1 to 300 parts by weight, even more preferably from 1 to 100 parts by weight for 100 parts by weight of the binder resin(solid content).

In the pressure-sensitive adhesive layer-carrying optical film according to the present invention, a pressure-sensitive adhesive layer is laminated over at least one surface of the optical film with an anchor layer interposed therebetween, wherein the anchor layer is made from the above-mentioned anchor-layer-forming coating liquid as a raw material. In the pressure-sensitive adhesive layer-carrying optical film, the pressure-sensitive adhesive layer may be laid over one surface of the optical film, or laid over both of the surfaces of the optical film.

The pressure-sensitive adhesive layer-carrying optical film of the present invention is characterized in that the anchor layer alone shows a transmittance reduction of 1% or less. In the present invention, the wording “transmittance reduction that the anchor layer alone shows” or any wording equivalent thereto denotes a reduction percentage obtained as follows: the transmittance of the polarizing film before the anchor layer is laminated over the film is measured; and then the transmittance of the polarizing film with the anchor layer laminated is measured; the transmittance of the “polarizing film after the laminating” is subtracted from the transmittance of the “the polarizing film before the laminating”; and the percentage of the transmittance reduction of the polarizing film is calculated therefrom. The reduction that the anchor layer alone shows is preferably 0.3% or less, more preferably 0.2% or less.

For the formation of the pressure-sensitive adhesive layer, an appropriate pressure-sensitive adhesive is usable. The kind thereof is not particularly limited. Examples of the pressure-sensitive adhesive include rubbery pressure-sensitive adhesives, acrylic pressure-sensitive adhesives, silicone pressure-sensitive adhesives, urethane pressure-sensitive adhesives, vinyl alkyl ether pressure-sensitive adhesives, polyvinyl alcohol pressure-sensitive adhesives, polyvinyl pyrrolidone pressure-sensitive adhesives, polyacrylamide pressure-sensitive adhesives, and cellulose pressure-sensitive adhesives.

Of these pressure-sensitive adhesives, preferred is one that is excellent in optical transparency, weather resistance, heat resistance and others, and has an adherable property giving appropriate adhesion, cohesiveness and tackiness. It is preferred to use an acrylic pressure-sensitive adhesive as the adhesive showing such characteristics.

The acrylic pressure-sensitive adhesive contains, as a base polymer, an acryl-based polymer having monomer units each made of an alkyl (meth)acrylate as a main skeleton. The wording “alkyl (meth)acrylate” denotes any alkyl acrylate and/or any alkyl methacrylate. In the present invention, the word “(meth)a” has a meaning equivalent thereto. Examples of the alkyl (meth)acrylate, which constitutes the main skeleton of the acryl-based polymer, may contain those having a linear or branched alkyl group having 1 to 20 carbon atoms. Examples thereof include methyl (meth)acrylate, ethyl (meth)acrylate, propyl (meth)acrylate, butyl (meth)acrylate, 2-ethylhexyl (meth)acrylate, isooctyl (meth)acrylate, isononyl (meth)acrylate, isomyristyl (meth)acrylate, and lauryl (meth)acrylate. These may be used alone or in combination. The average number of the carbon atoms of these alkyl groups is preferably from 3 to 9.

One or more copolymerizable monomers may be introduced into the acryl-based polymer by copolymerization in order to improve the polymer in tackiness and heat resistance. Specific examples of the copolymerizable monomer include hydroxyl-group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl-group-containing monomers such as (meth)acrylic acid, carboxyethyl (meth)acrylate, carboxypentyl (meth)acrylate, itaconic acid, maleic acid, fumaric acid, and crotonic acid; acid-anhydride-group-containing monomers such as maleic anhydride, and itaconic anhydride; a caprolactone adduct of acrylic acid; sulfonic-acid-group-containing monomers such as styrenesulfonic acid, allysulfonic acid, 2-(meth)acrylamide-2-methylpropanesulfonic acid, (meth)acrylamidepropanesulfonic acid, sulfopropyl (meth)acrylate, and (meth)acryloyloxynaphthalenesulfonic acid; and phosphoric-acid-group-containing monomers such as 2-hydroxyethylacryloyl phosphate.

Other examples of the monomer, for modifying the acryl-based polymer, include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and t-butylaminoethyl (meth)acrylate; alkoxyalkyl (meth)acrylate monomers such as methoxyethyl (meth)acrylate, and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Additional examples of the monomer which may be used for the modification include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile, and methacrylonitirle; epoxy-group-containing acrylic monomers such as glycidyl (meth)acrylate; glycol acrylate monomers such as polyethylene glycol (meth)acrylate, polypropylene glycol methacrylate, methoxyethylene glycol (meth)acrylate, and methoxypolypropylene glycol (meth)acrylate; acrylate monomers such as tetrahydrofurfuryl (meth)acrylate, fluorine (meth)acrylate, silicone (meth)acrylate, and 2-methoxyethyl acrylate.

The main component of the acryl-based polymer is an alkyl (meth)acrylate in light of the ratio by weight among the entire constituent monomers thereof. The ratio of the copolymerizable monomer in the acryl-based polymer is not particularly limited, and is preferably from about 0 to 20%, more preferably from about 0.1 to 15%, even more preferably from about 0.1 to 10% by weight of the entire constituent monomers.

Of these copolymerizable monomers, a hydroxyl-group-containing monomer or carboxyl-group-containing monomer is preferably used from the viewpoint of the tackiness and the endurance. Such a monomer becomes a point for reaction with a crosslinking agent. Since the hydroxyl-group-containing monomer, carboxyl-group-containing monomer and the like are rich in reactivity with an intermolecular crosslinking agent, they may be preferably used for improving the cohesiveness and the heat resistance of the resultant pressure-sensitive adhesive layer.

When the hydroxyl-group-containing monomer is a monomer having a hydroxyalkyl the alkyl group of which has 4 or more carbon atoms, the monomer is preferred since the monomer is high in reactivity with an isocyanate based compound (C) usable as a crosslinking agent. In the case of using, as the hydroxyl-group-containing monomer, a monomer having a hydroxyalkyl group the alkyl group of which has 4 or more carbon atoms, it is preferred to use, as the alkyl (meth)acrylate to be copolymerized therewith, an alkyl (meth)acrylate in which its alkyl group has carbon atoms the number of which is equal to or less than the number of the carbon atoms of the alkyl group of the hydroxyalkyl in the hydroxyl-group-containing monomer. For example, when 4-hydroxybutyl (meth)acrylate is used as the hydroxyl-group-containing monomer, it is preferred to use, as the alkyl (meth)acrylate to be copolymerized, butyl (meth)acrylate, or an alkyl (meth)acrylate having an alkyl group having carbon atoms the number of which is less than the number of the carbon atoms of the butyl group of butyl (meth)acrylate.

When the acryl-based polymer contains a hydroxyl-group-containing monomer and a carboxyl-group-containing monomer as copolymerizable monomers, these copolymerizable monomers are used in the above-mentioned proportion of the copolymerizable monomer, but preferably, the carboxyl-group-containing monomer is contained in a proportion of 0.1 to 10% by weight and the hydroxyl-group-containing monomer in a proportion of 0.01 to 10% by weight. The proportion of the carboxyl-group-containing monomer is more preferably from 0.2 to 8% by weight, even more preferably from 0.6 to 6% by weight. That of the hydroxyl-group-containing monomer is more preferably from 0.01 to 5% by weight, even more preferably from 0.03 to 3% by weight, most preferably from 0.05 to 1% by weight.

The average molecular weight of the acryl-based polymer is not particularly limited, but is preferably from about 300000 to 2500000. The acryl-based polymer may be produced by various known methods. For the production, an appropriate method may be selected from, for example, radical polymerization methods, such as bulk polymerization, solution polymerization and suspension polymerization methods. A radical polymerization initiator usable therefor may be any known initiator that may be of various types such as azo and peroxide types. The reaction temperature and the reaction period are usually set into the range of about 50 to 80° C. and that of 1 to 8 hours, respectively. Of the above-mentioned production methods, a solution polymerization method is preferred. A solvent usable for the acryl-based polymer may be generally, for example, ethyl acetate or toluene. The solution concentration is usually set into the range of about 20 to 80% by weight.

The above-mentioned pressure-sensitive adhesive is preferably rendered an adhesive composition containing a crosslinking agent. A polyfunctional compound blendable into the pressure-sensitive adhesive may be an organic crosslinking agent, or a polyfunctional metal chelate. Examples of the organic crosslinking agent include epoxy crosslinking agents, isocyanate crosslinking agents, imine crosslinking agents, and peroxide crosslinking agents. These crosslinking agents may be used alone or in combination of two or more thereof. The organic crosslinking agent is preferably any isocyanate crosslinking agent. The polyfunctional metal chelate is a substance in which a polyvalent metal is bonded to an organic compound through covalent bonding or coordinate bonding. Examples of the polyvalent metal atom include Al, Cr, Zr, Co, Cu, Fe, Ni, V, Zn, In, Ca, Mg, Mn, Y, Ce, Sr, Ba, Mo, La, Sn and Ti. In the organic compound, the atom related to the covalent bonding or coordinate bonding is, for example, an oxygen atom. Examples of the organic compound include alkyl esters, alcohol compounds, carboxylic acid compounds, ether compounds, and ketone compounds.

The blend ratio between the acryl-based polymer or any other base polymer and the crosslinking agent is not particularly limited. Usually, the content of the crosslinking agent (solid content) is preferably from about 0.001 to 20 parts by weight, more preferably from about 0.01 to 15 parts by weight for 100 parts by weight of the base polymer (solid content). The crosslinking agent is preferably any isocyanate crosslinking agent as described above. The content of the isocyanate crosslinking agent is preferably from about 0.001 to 2 parts by weight, more preferably from about 0.01 to 1.5 parts by weight for 100 parts by weight of the base polymer (solid content).

Furthermore, if necessary, the pressure-sensitive adhesive may appropriately contain various additives, such as an agent for imparting adherability, a plasticizer, a glass fiber, glass beads, a metal powder, a filler made of any other inorganic powder, a pigment, a colorant, a filler, an antioxidant, an ultraviolet absorber, and a silane coupling agent, as far as the achievement of the object of the present invention is not hindered. The pressure-sensitive adhesive may be rendered for example, a pressure-sensitive adhesive layer containing fine particles to show light diffusivity.

As the silane coupling agent, any silane coupling agent known in the prior art is usable without especial limitation. Examples thereof include epoxy-group-containing silane coupling agents such as γ-glycidoxypropyltrimethoxysilane, γ-glycidoxypropyltriethoxysilane, γ-glycidoxypropylmethyldiethoxysilane, and 2-(3,4-epoxycyclohexyl)ethyltrimethoxysilane; amino-group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine; (meth)acryl-group-containing silane coupling agents such as 3-acryloxypropyltrimethoxysilane, and 3-methacryloxypropyltriethoxysilane; and isocyanate-group-containing silane coupling agents such as 3-isocyanatopropyltriethoxysilane. However, when the pressure-sensitive adhesive layer contains the silane coupling agent, the generation of a solvent crack may be promoted in the anchor-layer-formed side surface of the optical film. Thus, the content of the silane coupling agent (solid content) in the base polymer (solid content) is preferably made as small as possible. Specifically, the content is preferably from about 0 to 3 parts by weight, more preferably from about 0 to 2 parts by weight, even more preferably from about 0 to 1 part by weight for 100 parts by weight of the base polymer (solid content).

The method according to the present invention for producing a pressure-sensitive adhesive layer-carrying optical film includes, before the step of forming an anchor layer, at least an adhesion facilitating treatment step of subjecting an anchor-layer-formed side surface of the optical film to an adhesion facilitating treatment, and an application step of applying an anchor-layer-forming coating liquid as described above onto the adhesion facilitating treatment surface of the optical film.

In the method according to the present invention for producing a pressure-sensitive adhesive layer-carrying optical film, it is preferred to paint the anchor-layer-forming coating liquid over an optical film so as to adjust the thickness of the painted coat before drying into 20 μm or less. If the thickness of this painted coat before drying is too large (the paint amount of the anchor-layer-forming coating liquid is too large), the coat is easily affected by the solvent so that the generation of a crack therein may be promoted. Meanwhile, if the thickness is too small, the adhesion between the optical film and the pressure-sensitive adhesive becomes insufficient so that the pressure-sensitive adhesive layer-carrying optical film may be deteriorated in endurance. From the viewpoint of the prevention of the crack generation and an improvement in the endurance, the thickness is preferably from 2 to 17 μm, more preferably from 4 to 13 μm. The painted coat thickness before the drying can be calculated out from the thickness of the anchor layer after the drying, and the proportion of the binder resin amount in the anchor-layer-forming coating liquid. The method for coating the anchor-layer-forming coating liquid is not particularly limited, and any coating method such as a coating method, a dipping method or a spraying method may be used.

Examples of the adhesion facilitating treatment include corona treatment, and plasma treatment. By subjecting the anchor-layer-formed side surface of the optical film to corona treatment or plasma treatment, the adhesion between the optical film and the pressure-sensitive adhesive layer can be further heightened.

In general, when an optical film is subjected to an adhesion facilitating treatment to heighten the adhesion between the optical film and a pressure-sensitive adhesive layer and subsequently an anchor layer is formed on the film, oxalic acid and the like are generated on the optical film by the adhesion facilitating treatment. The optical film is lowered in pH value, so that in the anchor-layer-forming coating liquid the binder resin component is declined in liquid stability. Thus, contaminants originating from the binder resin may be generated. However, in the method according to the present invention for producing a pressure-sensitive adhesive layer-carrying optical film, the mixed solvent, which is rich in water (the proportion of the alcohol ≦35% by weight), is used; thus, even if the binder component is lowered in pH value, the liquid stability thereof can be maintained. As a result, the generation of contaminants originating from the binder resin can be restrained to make it possible to produce a pressure-sensitive adhesive layer-carrying optical film in which the generation of contaminants is restrained in its anchor layer.

Unclear is a mechanism by which oxalic acid and the like are generated by subjecting the anchor-layer-formed side surface of the optical film to the adhesion facilitating treatment. However, the mechanism is presumed as follows:

(A) By electric discharge for the adhesion facilitating treatment, high-energy electrons or ions are caused to collide with the front surface of the optical film so that radicals or ions are generated in the optical film front surface.

(B) These react with surrounding N₂, O₂, H₂ and the like so that polar reactive groups such as carboxyl groups, hydroxyl groups and cyano groups are introduced into the surface. Simultaneously, oxalic acid is generated.

When the generated oxalic acid has been incorporated into the anchor-layer-forming coating liquid, the liquid is lowered in pH value to increase the generation amount of contaminants in the coating liquid, as described above.

The method according to the present invention for producing a pressure-sensitive adhesive layer-carrying optical film preferably further includes, after the application step, the anchor-layer-forming step wherein drying is performed under conditions satisfying both of the following (1) and (2):

(1) the drying temperature T is from 40 to 70° C., and

(2) a value obtained by multiplying the drying temperature T (° C.) by the drying period H (seconds), T×H, satisfies:

400≦(T×H)≦4000,

thereby removing the mixed solvent to form the anchor layer.

As the drying temperature T in the requirement (1) is made higher to dry the workpiece more rapidly, a solvent crack is more effectively prevented in the anchor-layer-formed side surface of the optical film. However, if the drying temperature T is too high, a deterioration of the optical film is promoted. In contrast, if the drying temperature T is too low, it is feared that the painted-coat external appearance of the anchor layer is deteriorated by an insufficiency of the drying, or a solvent crack is generated. It is therefore important that the drying temperature T is from 40 to 70° C., and is preferably from 45 to 60° C.

If the value obtained by multiplying the drying temperature T (° C.) by the drying period H (seconds) (T×H) in the requirement (2) is too large, a deterioration of the optical film is unfavorably promoted. If the value is too small, it is feared that the painted-coat external appearance of the anchor layer is deteriorated by an insufficiency of the drying, or a solvent crack is generated. Thus, to satisfy 400≦(T×H)≦4000 is important. To satisfy 500≦(T×H)≦2900 is preferred, to satisfy 500≦(T×H)≦2000 is more preferred, and to satisfy 600≦(T×H)≦1250 is particularly preferred.

If the drying period H is too long, a deterioration of the optical film is unfavorably promoted. If the period is too short, it is feared that the painted-coat external appearance of the anchor layer is deteriorated by an insufficiency of the drying, or a solvent crack is generated. Thus, the drying period H is preferably from 5 to 100 seconds, more preferably 5 to 70 seconds, even more preferably from 10 to 35 seconds.

In the method according to the present invention for producing a pressure-sensitive adhesive layer-carrying optical film, in the case of lengthening the period from a time when the anchor-layer-forming coating liquid is applied over the optical film to a time when the drying is started under the above-mentioned conditions, the painted-coat external appearance of the anchor layer may be deteriorated and further the generation of a solvent crack may be promoted in the anchor-layer-formed side surface of the optical film. Unclear is a cause that in this case of lengthening the period the solvent crack is promoted. It is however presumed that the mixed solvent in the anchor-layer-forming coating liquid penetrates and diffuses into the polymer constituting the optical film. It is therefore more preferred that this period is shorter. Specifically, the period is 30 seconds or shorter, more preferably 20 seconds or shorter, in particular preferably 10 seconds or shorter. The lower limit thereof is not particularly limited. However, when workability and others are considered, an example thereof is about 1 second.

The anchor layer thickness after drying (dry thickness) is preferably from 3 to 300 nm, more preferably from 5 to 180 nm, even more preferably from 11 to 90 nm. If the thickness is less than 3 nm, the anchor layer may not sufficiently gain an anchoring performance onto the optical film and the pressure-sensitive adhesive layer. If the thickness is more than 300 nm, the thickness of the anchor layer is too large so that a shortage in the strength thereof may cause cohesive failure in the anchor layer. Thus, the anchor layer may not gain a sufficient anchoring performance.

Generally, when an anchor-layer-formed side surface of an optical film is made of a norbornene resin or a (meth)acrylic resin, particularly, a norbornene resin, coating of an anchor-layer-forming coating liquid onto the surface easily causes a solvent crack in a reliability test at a high temperature (95° C. or higher). Causes therefor are as follows: (1) the glass transition temperature (Tg) of the optical film becomes close to the test temperature, so that the optical film turns brittle; and (2) the shrinkage stress of the polarizing film becomes large. Thus, for an article to be mounted in an automobile, or some other article that is required to undergo a reliability test at a high temperature (95° C. or higher), it is necessary to render, particularly, the conditions for drying the anchor-layer-forming coating liquid in the anchor-layer-forming step minutely-set conditions. However, when the above-mentioned drying conditions are applied, a pressure-sensitive adhesive layer-carrying optical film excellent in crack endurance can be effectively produced even when the anchor-layer-formed side surface of its optical film is provided with a norbornene resin or (meth)acrylic resin.

After formation of the anchor layer over the optical film, by forming a pressure-sensitive adhesive layer over the anchor layer, a pressure-sensitive adhesive layer-carrying optical film can be produced. The method for laminating the pressure-sensitive adhesive layer is not particularly limited. Examples thereof include a method of coating a pressure-sensitive adhesive solution over the anchor layer and then drying the workpiece, and a method of using a release sheet in which a pressure-sensitive adhesive layer is provided, and transferring the anchor layer. As the method for the coating, for example, a roll coating method such as reverse coating or gravure coating, a spin coating method, a screen coating method, a fountain coating method, a dipping method or a spraying method may be employed. The thickness of the pressure-sensitive adhesive layer is preferably from 2 to 150 μm, more preferably from 2 to 100 μm, in particular preferably from 5 to 50 μm. If the thickness of the pressure-sensitive adhesive layer is too small, there are easily caused inconveniences, such as an insufficient adhesion between the pressure-sensitive adhesive layer and the anchor layer, and a peel thereof from a glass interface. If the thickness is too large, foaming in the pressure-sensitive adhesive, or other inconveniences may easily be caused.

The constituting member of the release sheet may be, for example, an appropriate thin-leaf-like body, such as a paper, a film made of a synthetic resin such as polyethylene, polypropylene or polyethylene terephthalate, a rubber sheet, a cloth, a nonwoven cloth, a net, a foaming sheet, a metal foil, or a laminate made of two or more thereof. If necessary, a surface of the release sheet may be subjected to a peeling treatment for giving a low tackiness to the surface, such as a silicone treatment, a long-chain-alkyl treatment or a fluorine treatment, in order to improve the release sheet in peelability from the pressure-sensitive adhesive layer.

Each layer of the optical film, the pressure-sensitive adhesive layer and the like of the pressure-sensitive adhesive layer-carrying optical film obtained by the present invention may be given an ultraviolet absorbing power, for example, in the manner of treating the layer with an ultraviolet absorbent such as a salicylic acid ester compound, a benzophenol compound, a benzotriazole compound, a cyanoacrylate compound or a nickel complex compound.

The optical film used in the pressure-sensitive adhesive layer-carrying optical film of the present invention may be, for example, a polarizing film. An ordinarily usable example of the polarizing film is one having a transparent protective film on one or both surfaces of the polarizer.

The polarizer is not particularly limited, and those of various types may be used. Examples of the polarizer include a polarizer obtained by adsorbing a dichroic substance such as an iodine or a dichroic dye into a hydrophilic polymer film, such as a polyvinyl alcohol film, a partially formalated polyvinyl alcohol film or an ethylene/vinyl acetate copolymer partially saponified film, and then drawing the film monoaxially, or a polyene-oriented film made of, for example, a polyvinyl-alcohol dehydrated product or a polyvinyl-chloride dehydrochloride-treated product. Of such films, preferred is a polarizer composed of a polyvinyl alcohol film and a dichroic substance such as an iodine. The thickness of such a polarizer is not particularly limited, and in general, is approximately from 3 to 80 μm.

The polarizer obtained by dyeing a polyvinyl alcohol film with an iodine and then drawing the film monoaxially may be formed, for example, by immersing (a) polyvinyl alcohol (film) in an aqueous solution of iodine so as to be dyed, and then drawing the film into a length 3 to 7 times the original length. If necessary, the film may be immersed in an aqueous solution of potassium iodide or the like that may contain, for example, boric acid, zinc sulfate, or zinc chloride. Before dyeing, the polyvinyl alcohol film may be immersed in water to be washed as needed. Washing of the polyvinyl alcohol film with water makes it possible to clean off stains or a blocking inhibitor on surfaces of the polyvinyl alcohol film, and further causes the polyvinyl alcohol film to be swelled, thus producing an advantageous effect of preventing an unevenness in the dyed color or the like. The drawing may be performed after, while or before dyeing with iodine is performed. The drawing may be performed in an aqueous solution of boric acid, potassium iodide or the like, or in a water bath.

As the material constituting the transparent protective film, for example, a thermoplastic resin excellent in transparency, mechanical strength, thermal stability, water blocking performance, isotropy, and others are used. Specific examples of the thermoplastic resin include cellulose resins such as triacetylcellulose, polyester resin, polyethersulfone resin, polysulfone resin, polycarbonate resin, polyamide resin, polyimide resin, polyolefin resin, (meth)acrylate resin, cyclic polyolefin resin (norbornene based resin), polyarylate resin, polystyrene resin and polyvinyl alcohol resin; and mixtures thereof. The transparent protective film is bonded to one surface of the polarizer through the pressure-sensitive adhesive layer, while a thermosetting resin or ultraviolet curable resin of, for example, a (meth)acrylic, urethane, acrylic urethane, epoxy or silicone type may be used on the other surface as a transparent protective film. The transparent protective film may contain any one or more appropriate additives. Examples of the additives include an ultraviolet absorbent, an antioxidant, a lubricant, a plasticizer, a release agent, a coloring inhibitor, a flame retardation, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is 50% by weight or less, it is feared that a high transparency which a thermoplastic resin originally has cannot be sufficiently exhibited.

The transparent protective film may be a polymer film described in JP-A-2001-343529 (WO 01/37007), for example, a resin composition containing (A) a thermoplastic resin having, at its side chain, a substituted and/unsubstituted imide group, and (B) a thermoplastic resin having, at its side chain, a substituted and/or unsubstituted phenyl group and a nitrile group. A specific example thereof is a film made of a resin composition containing an alternate copolymer consisted of isobutylene and N-methylmaleimide, and acrylonitrile/styrene copolymer. As the film, a film made of an extruded mixed product of the resin composition or the like may be used. The film is small in retardance and optical elastic coefficient to make it possible to overcome an unevenness and other inconveniences based on a strain of the polarizing film. The film is also small in moisture permeability to be excellent in humidification endurance.

The thickness of the transparent protective film may be appropriately determined, and is generally from about 1 to 500 μm from the viewpoint of, for example, the strength, the handleability and other workabilities, and the thin layer property of the film. The thickness is preferably from 1 to 300 μm, more preferably from 5 to 200 μm, in particular preferably from 5 to 150 μm.

When transparent protective films are provided on both side surfaces of the polarizer, respectively, the protective films made of the same polymer material may be used, or the protective films made of different polymer materials or the like may be respectively used on both the surfaces.

For the transparent protective film in the present invention, it is preferred to use at least one selected from cellulose resin, polycarbonate resin, cyclic polyolefin resin and (meth)acrylic resin.

The cellulose resin is an ester made from cellulose and a fatty acid. Specific examples of the cellulose ester resin include triacetylcellulose, diacetylcellulose, tripropionylcellolose, and dipropionylcellulose. Of these celluloses, triacetylacellulose is particularly preferred. Triacetylcellulose is commercially available as many products, and is favorable from the viewpoint of easy availability and costs. Examples of a commercially available product of triacetylcellulose include “UV-50 (trade name; the same hereinafter)”, “UV-80”, “SH-80”, “TD-80U”, “TD-TAC” and “UZ-TAC”, manufactured by Fuji Film Corp.; and “KC Series”, manufactured by Konica Minolta Holdings Inc. About these triacetylcelluloses, generally, the in-plane retardance is substantially zero while the thickness-direction retardance (Rth) is about 60 nm.

As the triacetylcellulose (hereinafter referred to also as “TAC”), saponified triacetylcellulose (hereinafter referred to also as “saponified TAC”) may be used in order to improve the adhesion with the pressure-sensitive adhesive layer to which the protective film is to be bonded. Recently, however, TAC which is not subjected to any saponifying step (unsaponified TAC) is frequently used for a reduction in costs when a pressure-sensitive adhesive layer-carrying optical film is produced, and other purposes. However, when a pressure-sensitive adhesive solution is directly painted onto unsaponified TAC to form a pressure-sensitive adhesive layer, the anchoring power of the pressure-sensitive adhesive may become insufficient since the unsaponified TAC has, on the front surface thereof, no reaction point. Similarly, about (meth)acrylic resin or norbornene resin, the anchoring power of the pressure-sensitive adhesive (onto a layer of the resin) may also become insufficient since the resin is low in polarity. As a result, in order to overcome the insufficiency of the anchoring power, it becomes necessary to form an anchor layer onto unsaponified TAC, (meth)acrylic resin or norbornene resin. In particular, the unsaponified TAC tends to repel an anchor-layer-forming coating liquid since unsaponified TAC is inactive; thus, it is difficult to form an even anchor layer onto the unsaponified TAC. Accordingly, when unsaponified TAC is used, it is subjected to an adhesion facilitating treatment before an anchor layer is formed (on this TAC layer). As a result, the anchor layer can be evenly formed and the anchoring power of the pressure-sensitive adhesive layer is also improved. In short, when unsaponified TAC is used, it is indispensable to subject it to an adhesion facilitating treatment before an anchor layer is formed (similarly, when (meth)acrylic resin or norbornene resin is used, it is preferred to subject it to an adhesion facilitating treatment before an anchor layer is formed). The present inventors have made eager investigations to find out that when unsaponified TAC is subjected to an adhesion facilitating treatment, the generation rate of oxalic acid is remarkably increased so that there is a fear that the generation amount of contaminants may be unfavorably increased in the anchor layer. However, according to the present invention, by setting the ratio between water and an alcohol in a mixed solvent of an anchor-layer-forming coating liquid into the specific range, the generation of contaminants can be restrained when an anchor layer is formed onto an unsaponified TAC subjected to an adhesion facilitating treatment

A cellulose resin film with small thickness-direction retardance can be obtained, for example, by treating the cellulose resin. Examples of a method therefor include a method including bonding, to a common cellulose film, a base film on which a solvent such as cyclopentanone or methyl ethyl ketone is painted, the base film being made of, for example, polyethylene terephthalate, polypropylene or stainless steel, heating/drying the workpiece (for example, at 80 to 150° C. for about 3 to 10 minutes) and then peeling the base film; and a method including coating, onto a common cellulose resin film, a solution in which norbornene resin, (meth)acrylic resin or the like is dissolved in a solvent such as cyclopentanone or methyl ethyl ketone, heating/drying the workpiece (for example, at 80 to 150° C. for about 3 to 10 minutes) and then peeling the painted film.

As the cellulose resin film with small thickness-direction retardance, a fatty acid substituted cellulose resin film having a controlled fatty acid substitution degree may be used. Commonly used triacetylcellulose has an acetic acid substitution degree of about 2.8. Preferably, by controlling the acetic acid substitution degree to 1.8 to 2.7, the Rth can be reduced. By adding, to the fatty acid substituted cellulose resin, a plasticizer such as dibutyl phthalate, p-toluenesulfonanilide or acetyltriethyl citrate, the Rth can be controlled into a small value. The addition amount of the plasticizer is preferably 40 parts by weight or less, more preferably from 1 to 20 parts by weight, even more preferably from 1 to 15 parts by weight for 100 parts by weight of the fatty acid substituted cellulose resin.

A specific example of the cyclic polyolefin resin is preferably norbornene resin. The cyclic polyolefin resin is a generic name of any resin obtained by polymerizing a cyclic olefin as a polymer unit. Examples thereof include resins described JP-A-1-240517, JP-A-3-14882, and JP-A-3-122137. Specific examples thereof include a ring-opened (co)polymer made from a cyclic olefin, an addition polymer made from a cyclic olefin, and a copolymer (typically, a random copolymer) made from a cyclic olefin and an α-olefin such as ethylene or propylene; graft polymers obtained by modifying these polymers, respectively, with an unsaturated carboxylic acid or a derivative thereof; and hydrogenated products thereof. A specific example of the cyclic olefin is a norbornene based monomer.

The cyclic polyolefin resin is commercially available as various products. Specific examples thereof include products, “ZEONEX” and “ZEONOR”, manufactured by Zeon Corp., “ARTON” manufactured by JSR Corp., “TOPAS” manufactured by Ticona Co., and “APEL” manufactured by Mitsui Chemicals, Inc.

About the (meth)acrylic resin, the Tg (glass transition temperature) thereof is preferably 115° C. or higher, more preferably 120° C. or higher, even more preferably 125° C. or higher, in particular preferably 130° C. or higher. When the Tg is 115° C. or higher, the polarizing film can be excellent in endurance. The upper limit of the Tg of the (meth)acrylic resin is not particularly limited. The limit is preferably 170° C. or lower from the viewpoint of the shapability of the resin and the like. By use of the (meth)acrylic resin, a film can be obtained which has an in-plane retardance (Re) of substantially zero and a thickness-direction retardance (Rth) of the same.

As the (meth)acrylic resin, any appropriate (meth)acrylic resin may be used as far as the advantageous effects of the present invention are not damaged. Examples thereof include poly(meth)acrylates such as polymethyl methacrylate, methyl methacrylate/(meth)acrylic acid copolymer, methyl methacrylate/(meth)acrylate copolymer, methyl methacrylate/acrylate/(meth)acrylic acid copolymer, and methyl (meth)acrylate/styrene copolymer (such as MS resin); and polymers having an alicyclic hydrocarbon group (such as methyl (meth)acrylate/cyclohexyl methacrylate copolymer, methyl (meth)acrylate/norbornyl (meth)acrylate copolymer). Preferably, poly(a C1-C6 alkyl (meth)acrylate) such as polymethyl (meth)acrylate may be mentioned. The resin is more preferably methyl methacrylate resin containing methyl methacrylate as a main component (in a proportion of 50 to 100% by weight, more preferably from 70 to 100% by weight).

Specific examples of the (meth)acrylic resin include ACRYPET VH and ACRYPET VRL20A, manufactured by Mitsubishi Rayon Co., Ltd.; and (meth)acrylic resins having in the molecule thereof a cyclic structure, and high-Tg (meth)acrylic resins obtained by intramolecular crosslinking or intramolecular cyclization reaction, each described in JP-A-2004-70296.

As the (meth)acrylic resin, a (meth)acrylic resin having a lactone ring structure may be used, since the resin is high in heat resistance and transparency, and gains a high mechanical strength when biaxially drawn.

Examples of the (meth)acrylic resin having a lactone ring structure include (meth)acrylic resins described in, for example, JP-A-2000-230016, JP-A-2001-151814, JP-A-2002-120326, JP-A-2002-254544, and JP-A-2005-146084, which have a lactone ring structure.

The (meth)acrylic resin having a lactone ring structure preferably has a ring-like structure represented by the following general formula (1):

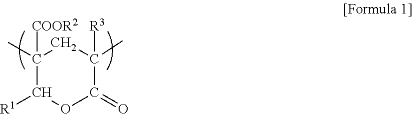

wherein R¹, R² and R³ each independently represent a hydrogen atom or an organic residue having 1 to 20 carbon atoms. The organic residue may have an oxygen atom.

The content by percentage of the lactone ring structure represented by the general formula (1) in the (meth)acrylic resin structure having a lactone ring structure is preferably from 5 to 90% by weight, more preferably from 10 to 70% by weight, even more preferably from 10 to 60% by weight, in particular preferably from 10 to 50% by weight. If this content by percentage is less than 5% by weight, there is a fear that the resin may be insufficient in heat resistance, solvent resistance, and surface hardness. If the content by percentage is more than 90% by weight, there is a fear that the resin may be poor in shaping-processability.

For the (meth)acrylic resin having a lactone ring structure, the mass average molecular weight, which may be referred to as the weight average molecular weight, is preferably from 1000 to 2000000, more preferably from 5000 to 1000000, even more preferably from 10000 to 500000, in particular preferably from 50000 to 500000. If the mass average molecular weight is out of the range, the resin is not preferred from the viewpoint of the shaping-processability.

For the (meth)acrylic resin having a lactone ring structure, the Tg thereof is preferably 115° C. or higher, more preferably 120° C. or higher, even more preferably 125° C. or higher, in particular preferably 130° C. or higher. When the resin is integrated, in the form of a transparent protective film, into a polarizing film, the polarizing film is excellent in endurance since the Tg is 115° C. or higher. The upper limit of the Tg of the (meth)acrylic resin having a lactone ring structure is not particularly limited, but is preferably 170° C. or lower from the viewpoint of the shaping property and others.

For the (meth)acrylic resin having a lactone ring structure, a more preferred result is obtained as the total light transmittance of a shaped product obtained there from by injection molding is higher, wherein the transmittance is measured in accordance with ASTM-D-1003. The total light transmittance is preferably 85% or more, more preferably 88% or more, even more preferably 90% or more. The total light transmittance is a reference for the transparency. If the total light transmittance is less than 85%, the shaped product may be declined in transparency.

As the transparent protective film, usually, a film is used which has an in-plane retardance of less than 40 nm, and a thickness-direction retardance of less than 80 nm. The in-plane retardance Re is represented by Re=(nx−ny)×d. The thickness-direction retardance is represented by Rth=(nx−nz)×d. The Nz coefficient is represented by Nz=(nx−nz)/(nx−ny). In these equations, nx, ny and nx represent the refractive index in the slow axis direction, that in the fast axis direction, and that in the thickness direction of the film, respectively, and d (nm) represents the thickness of the film. The slow axis direction is defined as the direction in the in-plane of the film in which the refractive index is the largest. It is preferred that the transparent protective film is colored as little as possible. It is preferred to use a protective film having a retardance value of −90 nm to +75 nm in the thickness direction. The use of this film, the retardance value (Rth) of which is from −90 nm to +75 nm in the thickness direction, makes it possible to overcome substantially completely a coloration (optical coloration) of the polarizing film caused by the transparent protective film. The retardance value (Rth) in the thickness direction is more preferably from −80 nm to +60 nm, in particular preferably from −70 nm to +45 nm.

Meanwhile, as the transparent protective film, a retardation plate having an in-plane retardance of 40 nm or more and/or a thickness-direction retardance of 80 nm or more may be used. The in-plane retardance and the thickness-direction retardance are usually controlled into the range of 40 to 200 nm and that of 80 to 300 nm, respectively. When a retardation plate is used as a transparent protective film, the whole can be made thin since this retardation plate functions also as a transparent protective film.

Examples of the retardation plate include a birefringence film obtained by drawing a polymer material monoaxially or biaxially, an oriented film made of a liquid crystal polymer, and a product in which an oriented layer made of a liquid crystal polymer is supported with a film. The thickness of the retardation plate is not particularly limited, and is generally from about 20 to 150 μm.

Examples of the polymer material include polyvinyl alcohol, polyvinyl butyral, polymethyl vinyl ether, polyhydroxyethyl acrylate, hydroxyethylcellulose, hydroxypropylcellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cellulose resin, and cyclic polyolefin resin (norbornene resin); and binary, ternary various copolymers thereof, graft copolymers thereof, and blends of two or more thereof. These polymer materials may be made into oriented products (stretched films) by drawing or the like.

The liquid crystal polymer may be of various types, such as a main chain type and a side chain type in which a conjugated linear atomic group (mesogen) for giving a liquid crystal orientation is introduced into a main chain and a side chain of a polymer, respectively. Specific examples of the main chain type liquid crystal polymer include a nematic orientation polyester liquid crystal polymer, a discotic polymer and a cholesteric polymer each having a structure in which a mesogen group is bonded to a spacer moiety for giving flexibility. A specific example of the side chain type liquid crystal polymer is a polymer having, as a main chain skeleton, polysiloxane, polyacrylate, polymethacrylate or polymalonate, and having, as a side chain, a mesogen moiety made of a para-substituted cyclic compound unit capable of giving nematic orientation via a spacer moiety made of a conjugated atomic group. These liquid crystal polymers are obtained, for example, by developing a solution of the liquid crystal polymer onto an oriented surface such as a rubbing treated surface of a thin film made of, for example, polyimide or polyvinyl alcohol formed on a glass plate or a surface onto which silicon oxide is obliquely evaporated and then treating the workpiece thermally.

The retardation plate may be a plate having an appropriate retardance corresponding to a use purpose thereof, for example, a plate for compensating for coloration or a viewing angle change on the basis of the birefringence of various wavelength plates or liquid crystal layers. The retardation plate may be a product in which two or more retardation plates are laminated onto each other to be controlled in retardance and other optical properties.

As the retardation plate, those satisfying relationships of nx=ny>nz, nx>ny>nz, nx>ny=nz, nx>nz>ny, nz=nx>ny, nz>nx>ny, or nz>nx=ny, respectively are selected and used in accordance with a use purpose of various types. It is to be noted that the relationship “ny=nz” denotes not only a case where ny is completely equal to nz but also a case where ny is substantially equal to nz.

For example, in a retardation plate satisfying “nx>ny>nz”, it is preferred to use a retardation plate having an in-plane retardance of 40 to 100 nm, a thickness-direction retardance of 100 to 320 nm and an Nz coefficient of 1.8 to 4.5. In a retardation plate satisfying “nx>ny=nz” (positive A plate), for example, it is preferred to use a retardation plate having an in-plane retardance of 100 to 200 nm. In a retardation plate satisfying “nz=nx>ny” (negative A plate), for example, it is preferred to use a retardation plate having an in-plane retardance of 100 to 200 nm. Ina retardation plate satisfying “nx>nz>ny”, for example, it is preferred to use a retardation plate having an in-plane retardance of 150 to 300 nm and an Nz coefficient of more than 0, and 0.7 or less. As described above, for example, a retardation plate satisfying nx=ny>nz, nz>nx>ny, or nz>nx=ny may be used.

The transparent protective film may be appropriately selected in accordance with a liquid crystal display device in which the film is used. In the case of, for example, a device in a VA (vertical alignment) mode, which may be an MVA or PVA mode, it is desired that a transparent protective film on at least one side (cell side) of its polarizing film has a retardance. Specifically, the retardance desirably satisfies the following: Re=0 to 240 nm, and Rth=0 to 500 nm. About the three dimensional refractive indexes thereof, it is desired to satisfy nx>ny=nz, nx>ny>nz, nx>nz>ny, or nx=ny>nz (a positive A plate, a biaxial film or a negative C plate). In the VA mode device, it is preferred to use a combination of a positive A plate with a negative C plate, or a biaxial film alone. In the case of using polarizing films over and under its liquid crystal cell, respectively, respective transparent protective films over and under the liquid crystal cell may have a retardance, or either one of the protective films may have a retardance.

In the case of, for example, a device in an IPS (in-plane switching) mode, which may be an FFS mode, a transparent protective film on a single side of its polarizing film may or may not have a retardance and in any case, it may be used. For example, when the transparent protective film has no retardance, it is desired that transparent protective films, which include the protective film described just above, over and under (cell side) the liquid crystal cell each have no retardance. When the transparent protective film has a retardance, it is desired that transparent protective films, which include the protective film, over and under the liquid crystal cell each have a retardance, or either one of these films has a retardance (for example, a case where the upper transparent protective film is a biaxial film satisfying the relationship “nx>nz>ny” and the lower transparent protective film has no retardance, or a case where the upper transparent protective film is a positive A plate and the lower transparent protective film is a positive C plate). When the transparent protective film has a retardance, the retardance desirably satisfies the following: Re=−500 to 500 nm, and Rth=−500 to 500 nm. For the three dimensional refractive indexes thereof, it is desired to satisfy nx>ny=nz, nx>nz>ny, nz>nx=ny, or nz>nx>ny (a positive A plate, a biaxial film or a positive C plate).

When the above-mentioned film, which has a retardance, is bonded to a transparent protective film having no retardance, the above-mentioned function can be given thereto.

The above-mentioned transparent protective films may be subjected to surface-modifying treatment, before a pressure-sensitive adhesive is painted thereto, to improve the adhesion thereof onto a polarizer. Specific examples of the treatment include corona treatment, plasma treatment, flame treatment, ozone treatment, primer treatment, glow treatment, saponifying treatment, and treatment by a coupling agent. An antistatic layer may be appropriately formed thereon.

A hard coat layer or a treatment for reflection reduction, sticking prevention, a treatment for diffusion or anti-glaring may be applied onto the surface of the transparent protective film to which no polarizer is bonded.

The hard coat layer is a layer for preventing a scratch in the polarizing film surface, and may be formed, for example, in a manner of applying, onto the surface of the transparent protective film, a cured coat that is made of an appropriate ultraviolet curable resin, such as an acrylic or silicone resin, and is excellent in hardness, slipping property and others. The reflection reduction treatment is conducted to reduce reflection of external light on the surface of the polarizing film, and may be attained by forming a reflection reduction film according to a conventional method. The sticking prevention treatment may be conducted to prevent the transparent protective film from adhering closely to an adjacent layer (such as a diffusion plate on the back light side of a liquid crystal display device).

The anti-glaring treatment is conducted, for example, in order to prevent a matter that external light is reflected on the surface of the polarizing film so that light transmitted through the polarizing film is hindered from being viewed. This treatment can be attained by giving a structure of fine irregularities to the surface of the transparent protective film in an appropriate manner, for example, a surface-roughening manner by a sandblasting manner or an embossing manner, or a manner of incorporating transparent fine particles. As the fine particles incorporated into the surface fine-irregularity-structure to form this structure, for example, transparent fine particles, such as inorganic fine particles that have an average particle diameter of 0.5 to 20 μm, are made of, for example, silica, alumina, titania, zirconia, tin oxide, indium oxide, cadmium oxide or antimony oxide, and may have electroconductivity, or organic fine particles made of, for example, a crosslinked or uncrosslinked polymer may be used. When the surface fine-irregularity-structure is formed, the amount of the fine particles used is generally from about 2 to 70 parts by weight, preferably from 5 to 50 parts by weight for 100 parts by weight of a transparent resin that forms the surface fine-irregularity-structure. The antiglare layer may be a layer functioning also as a diffusion layer for enlarging the viewing angle or the like (for example, a viewing angle enlarging function) by causing light transmitted through the polarizing film to diffuse.

The above-mentioned reflection reduction layer, sticking prevention layer, diffusion layer and antiglare layer, and the like may be provided on the transparent protective film itself, or otherwise may be provided as an optical layer in the form of a member separated from the transparent protective film.

For the treatment for adhering the polarizer and the transparent protective film, an adhesive is used. Examples of the adhesive include isocyanate adhesives, polyvinyl alcohol adhesives, gelatin adhesives, vinyl latex adhesives, and water-affinitive polyesters. The adhesive is usually used in the form of an aqueous solution thereof, and usually contains 0.5 to 60% by weight of a solid. Besides the above, examples of the adhesive for the polarizer and the transparent protective film include ultraviolet curable adhesives, and electron beam curable adhesives. The electron beam curable adhesives for a polarizing film exhibit suitable tackiness for the above-mentioned various transparent protective films. A metal compound filler may be incorporated into the adhesive used in the present invention.

The optical film may be an optical layer that may be used to form, for example, a liquid crystal display device. Examples thereof include reflectors, anti-transmission plates, retardation plates, which may be, for example, ½ and ¼ wavelength plates, viewing angle compensation films, brightness enhancement films, and surface treatment films. These may be used alone as an optical film, or may be used in a form that two or more thereof are laminated onto each other when practically used.

A surface treatment film may be provided by being bonded onto a front plate. Examples of the surface treatment film include a hard coat film for giving scratch resistance to a surface, an antiglare treatment film to prevent casting a glare on an image display device, and reflection reduction films such as an antireflective film and a low reflective film. The front plate is provided by being bonded onto the front surface of an image display device, such as a liquid crystal display device, an organic EL display device, a CRT or a PDP, to protect the image display device, give a high-class impression thereto, and discriminate the device from others by a design thereof. The front plate may be used as a supporter for a λ/4 plate in a 3D-TV. For example, in a liquid crystal display device, a front plate is located over its polarizing film at the viewing-side of the device. When the pressure-sensitive adhesive layer in the present invention is used, a glass substrate as the front plate produces advantageous effects; besides, a plastic substrate, such as a polycarbonate substrate or polymethyl methacrylate substrate, produces the same advantageous effects.

The optical film in which two or more of the above-mentioned optical layers are laminated on a polarizing film may be formed by a method of laminating the optical layers successively and individually in a process for producing, for example, a liquid crystal display device. The optical film obtained by laminating the optical layers beforehand is excellent in quality stability, fabricating workability and the like to produce an advantage of being able to enhance the process for producing a liquid crystal display device and the like. For the laminating, any appropriate adhesive means, such as a pressure-sensitive adhesive layer, may be used. When the polarizing film is adhered to other optical layers, an optical axis of these members may be set to an appropriate layout angle in accordance with, for example, a target retardance property.

The pressure-sensitive adhesive layer-carrying optical film of the present invention is preferably usable for formation of various image display devices such as a liquid crystal display device, and others. The liquid crystal display device may be formed according to the prior art. Specifically, a liquid crystal display device is generally formed, for example, by fabricating appropriately a display panel such as a liquid crystal cell, a pressure-sensitive adhesive layer-carrying optical film, an optional lighting system and other constituent members as needed, and integrating a driving circuit thereinto. In the present invention, a liquid crystal display device is formed according to such a conventional method, and is not particularly limited except that the pressure-sensitive adhesive layer-carrying optical film according to the present invention is used. For the liquid crystal cell, a cell in any mode, such as a TN, STN, π, VA, or IPS mode may be used.

The present invention is used to make it possible to form an appropriate liquid crystal display device, such as a liquid crystal display device in which the pressure-sensitive adhesive layer-carrying optical film is arranged on one or both surfaces of a display panel such as a liquid crystal cell, or a display device in which a backlight or a reflector is used for a lighting system. In this case, the optical film according to the present invention may be provided at one or both sides of the display panel such as the liquid crystal cell. When the optical films are provided at both sides, the films may be the same or different. Further, when the liquid crystal display device is formed, any appropriate members such as a diffusion plate, an antiglare layer, a reflection reduction film, a protective plate, a prism array, a lens array sheet, a light diffusion plate, a backlight and the like may be arranged as one or more layers at any appropriate positions.

The following will describe an organic electroluminescence device (organic EL display device: OLED). Generally, in an organic EL display device, a transparent electrode, an organic luminous layer and a metal electrode are laminated in order onto a transparent substrate to form a luminous body (organic electroluminescence body). Here, the organic luminous layer is a laminate composed of various organic thin films. As the structure of this layer, structures having a combination that may be of various types are known, for example, a laminate composed of a hole injection layer made of, for example, a triphenylamine derivative, and a luminous layer made of a fluorescent organic solid such as anthracene, a laminate composed of such a luminous layer and an electron injection layer made of, for example, a perylene derivative, or a laminate composed of a hole injection layer, a luminous layer and an electron injection layer as described herein.

In an organic EL display device, by applying a voltage to its transparent electrode and its metal electrode, holes and electrons are injected into the organic luminous layer, and these holes and electrons are recombined to generate an energy. In turn, the energy excites the fluorescent substance. When the excited fluorescent substance is returned to a ground state thereof, light is radiated. By this principle, light is emitted. The mechanism of the recombination in the middle of this process is equivalent to that of ordinary diodes. As can be expected also from this matter, the electric current and the luminescence intensity show an intense non-linearity, with rectification, relative to an applied voltage.

In an organic EL display device, at least one of its electrodes needs to be transparent to take out luminescence from its organic luminous layer. Usually, its transparent electrode made of a transparent electroconductor such as indium tin oxide (ITO) is used as a positive electrode. Meanwhile, in order to make the injection of electrons easy to raise the luminescence efficiency, it is important to use a substance with small working function for a negative electrode. Usually, an electrode made of a metal, such as Mg—Ag or Al—Li, is used.

In an organic EL display device having such a structure, its organic luminous layer is formed of a very thin film having a thickness of about 10 nm. Thus, like the transparent electrode, the organic luminous layer transmits light substantially completely. As a result, when no light is emitted, light enters from a surface of the transparent substrate, penetrates the transparent electrode and the organic luminous layer and then reflects on the metal electrode and again goes out to the surface of the transparent substrate. Accordingly, when the organic EL display device is viewed from the outside, the display surface of the device looks like a mirror plane.

In an organic EL display device containing an organic electroluminescent body which is formed by providing a transparent electrode on the front surface side of the organic luminous layer which emits light by applying a voltage thereto, and further providing a metal electrode on the rear surface side of the organic luminous layer, a polarizing film may be located on the front surface side of the transparent electrode and further a retardation plate may be interposed between the transparent electrode and the polarizing film.

Since the retardation plate and the polarizing film have an action of polarizing light radiated thereinto from the outside and then reflected on the metal electrode, there is an effect that the mirror plane of the metal electrode cannot be viewed from the outside by the polarizing action. In particular, when the retardation plate is composed of a ¼ wavelength plate and the angle between the respective polarizing directions of the polarizing film and the retardation plate is adjusted to π/4, the mirror plane of the metal electrode can be completely shielded.

In short, about external light radiated into this organic EL display device, only its linearly polarized light component is transmitted by effect of the polarizing film. This linearly polarized light ray is generally turned to an elliptically polarized light ray. However, particularly, when the retardation plate is a ¼ wavelength plate and further the angle between the respective polarizing directions of the polarizing film and the retardation plate is π/4, the light ray is turned to a circularly polarized light ray.

This circularly polarized light ray is transmitted through the transparent substrate, the transparent electrode, and the organic thin film, reflected on the metal electrode, and again transmitted through the organic thin film, the transparent electrode and the transparent substrate to be again turned to a linearly polarized light ray through the retardation plate. This linearly polarized light ray is perpendicular to the polarizing direction of the polarizing film so as not to be transmissible through the polarizing film. As a result, the mirror plane of the metal electrode can be completely shielded.

### EXAMPLES

Hereinafter, the present invention will be specifically described by way of examples. However, the present invention is not limited by these examples. In each of the examples, the word “part(s)” and the symbol “%” denote “part(s) by weight” and “% by weight”, respectively.

### Example 1

### Formation of Optical Film (Polarizing Film):

### <Polarizer>

A 75-μm-thick polyvinyl alcohol film with an average degree of polymerization of 2,400 and a degree of saponification of 99.9% by mole was immersed in warm water at 30° C. for 60 seconds so that it was allowed to swell. The film was then immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C. After the stretching, the film was dried in an oven at 40° C. for 3 minutes to give a PVA-based polarizer (23 μm in thickness).

### <Transparent Protective Films

An 80-μm-thick triacetylcellulose (TAC) film was used as a transparent protective film without being subjected to saponification, corona treatment, and other processes (hereinafter, TAC not having undergone saponification, corona treatment, and other processes is also referred to as “unsaponified TAC”).

### <Active Energy Rays>

The active energy rays used were as follows: ultraviolet rays (gallium-containing metal halide lamp); irradiator, Light Hammer 10 manufactured by Fusion UV Systems, Inc.; valve, Vvalve; peak illuminance, 1,600 mW/cm2; total dose, 1,000 mJ/cm2 (wavelength 380-440 nm). The illuminance of ultraviolet rays was measured using Sola-Check System manufactured by Solatell Ltd.

### Preparation of Active Energy Ray Curable Adhesive Composition:

Components described just below were mixed with each other, and the mixture was stirred at 50° C. for 1 hour to yield an active energy ray curable adhesive composition. Each of the components used was as follows.

(1) HEAA (hydroxyethylacrylamide) manufactured by KOHJIN Film & Chemicals Co., Ltd., which is capable of forming a homopolymer with a Tg of 123° C.

(2) ARONIX M-220 (tripropylene glycol diacrylate) manufactured by TOAGOSEI CO., LTD., which is capable of forming a homopolymer with a Tg of 69° C.

(3) ACMO (acryloylmorpholine) manufactured by KOHJIN Film & Chemicals Co., Ltd., 22.9 in SP value, which is capable of forming a homopolymer with a Tg of 150° C.

(4) Photopolymerization Initiator

KAYACURE DETX-S (diethylthioxanthone) manufactured by Nippon Kayaku Co., Ltd.

IRGACURE 907

(2-methyl-1-(4-methylthiophenyl)-2-morpholinopropane-1-one) manufactured by BASF

The active energy ray-curable adhesive composition containing 38.3 parts by weight of HEAA, 19.1 parts by weight of ARONIX M-220, 38.3 parts by weight of ACMO, 1.4 parts by weight of KAYACURE DETX-S, and 1.4 parts by weight of IRGACURE 907 was applied to two pieces of the unsaponified TAC film using MCD Coater (manufactured by FUJI MACHINE MFG. CO., LTD., cell form, honeycomb; the number of gravure roller lines, 1000/inch; rotational speed, 140% relative to line speed). The adhesive composition was applied so as to form a 0.5-μm-thick coating. The unsaponified TAC films each with the coating were bonded to both sides of the polarizer, respectively, using a roller machine. The resulting laminate was then heated to 50° C. from the unsaponified TAC film sides (both side) using an IR heater, and the ultraviolet rays were applied to both sides to cure the active energy ray-curable adhesive composition. The laminate was then air-dried at 70° C. for 3 minutes to give a polarizing film including the polarizer and the unsaponified TAC films bonded to both sides of the polarizer. The lamination was performed at a line speed of 25 m/minute.

A corona treatment (0.1 kW, 3 m/minute, 300 mm wide) was performed as an adhesion facilitating treatment on one surface of the polarizing film, where an anchor layer was to be formed (the unsaponified TAC film-side surface on which a pressure-sensitive adhesive layer was to be formed).

(Preparation of Pressure-Sensitive Adhesive Solution A)

To a reaction vessel equipped with a condenser tube, a nitrogen-introducing tube, a thermometer, and a stirrer were added 99 parts of butyl acrylate, 1.0 part of 4-hydroxybutyl acrylate, and 0.3 parts of 2,2-azobisisobutyronitrile (based on 100 parts of the solids of the monomers) together with ethyl acetate. Under a nitrogen gas stream, the mixture was allowed to react at 60° C. for 4 hours. Ethyl acetate was then added to the reaction liquid, so that a polymer solution A containing an acryl-based polymer with a weight average molecular weight of 1,650,000 was obtained (30% by weight in solid concentration). Based on 100 parts of the solid in the acryl-based polymer solution A, 0.3 parts of dibenzoyl peroxide (NYPER BMT manufactured by NOF CORPORATION), 0.1 parts of trimethylolpropane xylylene diisocyanate (Takenate D110N manufactured by Mitsui Takeda Chemicals, Inc.), and 0.2 parts of a silane coupling agent (A-100 manufactured by Soken Chemical & Engineering Co., Ltd., an acetoacetyl group-containing silane coupling agent) were added to the polymer solution A, so that an acryl-based pressure-sensitive adhesive solution A was obtained.

(Preparation of Pressure-Sensitive Adhesive Solution B)

To a reaction vessel equipped with a condenser tube, a nitrogen-introducing tube, a thermometer, and a stirrer were added 94.9 parts of butyl acrylate, 5 parts of acrylic acid, 0.1 parts of 2-hydroxyethyl acrylate, and 0.3 parts of dibenzoyl peroxide (NYPER BMT40 (SV) manufactured by NOF CORPORATION) (based on 100 parts of the solids of the monomers) together with ethyl acetate. Under a nitrogen gas stream, the mixture was allowed to react at 60° C. for 7 hours. Ethyl acetate was then added to the reaction liquid, so that a polymer solution B containing an acryl-based polymer with a weight average molecular weight of 2,200,000 was obtained (30% by weight in solid concentration). Based on 100 parts of the solid in the acryl-based polymer solution B, 0.6 parts of trimethylolpropane tolylene diisocyanate (CORONATE L manufactured by Nippon Polyurethane Industry Co., Ltd.) and 0.075 part of γ-glycidoxypropylmethoxysilane (KBM-403 manufactured by Shin-Etsu Chemical Co., Ltd.) were added to the polymer solution B, so that an acryl-based pressure-sensitive adhesive solution B was obtained.

### Preparation of Anchor-Layer-Forming Coating Liquid:

To a (mixed) solution, the proportion by weight of water therein being 100% by weight, was added a solution containing a urethane polymer, the percentage of any solid therein being from 30 to 90% by weight, and a polythiophene based polymer, the percentage thereof being from 10 to 50% by weight [trade name: DENATRON P-580W, manufactured by Nagase ChemteX Corp.], and a solution containing an oxazoline-group-containing acryl-based polymer (percentage of any solid therein: 10 to 70% by weight) and a polyoxyethylene-group-containing methacrylate (percentage of any solid therein: 10 to 70% by weight) [trade name: EPOCROSWS-700, manufactured by Nippon Shokubai Co., Ltd.], to prepare a solution in which the concentration of any solid (base concentration) therein was 0.4% by weight. A Mayer bar #5 was used to apply the prepared solution onto the unsaponified TAC film side surface of the polarizing film. Before the workpiece was put into a drying oven, it was allowed to stand still for a period (period up to the start of drying) of 5 seconds. It was then dried at 50° C. for 25 seconds to form a coated anchor layer having a thickness of 48 nm. The applied coat thickness before dried was about 12 μm, which was calculated from the dry thickness. The working was performed in an atmosphere having a temperature of 23° C. and a relative humidity of 55%. For reference, when a Mayer bar is used for coating, the painted coat thickness before dried is substantially consistent with the clearance of the Mayer bar. Accordingly, the desired thickness of any painted coat before dried can be adjusted to some degree by changing the wire number of the Mayer bar to be used. Table 1 shows the respective clearances of individual Mayer bar numbers.

TABLE 1

| Target wet | The wire |
|---|---|
| thickness [μm] | number |
| 2 | #1 |
| 5 | #2 |
| 12 | #5 |
| 17 | #7 |
| 20 | #8 |
| 28 | #11 |

### Production of Pressure-Sensitive Adhesive Layer-Carrying Optical Film:

A fountain coater was used to apply the pressure-sensitive adhesive solution A evenly onto a surface of a polyethylene terephthalate film (substrate) treated with a silicone release agent. The workpiece was dried in an air-circulating type thermostat oven at 155° C. temperature for 2 minutes to form a pressure-sensitive adhesive layer having a thickness of 20 μm on the surface of the substrate. Next, a separator on which the pressure-sensitive adhesive layer was formed was shifted onto the anchor-layer-carrying optical film. In this way, a pressure-sensitive adhesive layer-carrying optical film was produced.

### Examples 2 to 16, and Comparative Examples 1 to 5

In each of these examples, a pressure-sensitive adhesive layer-carrying optical film was produced in the same way as in Example 1 except that the following were changed as described in Table 2: the kind of the transparent protective film on the anchor-layer-formed side surface (pressure-sensitive adhesive layer-laminated side surface) in the optical film (polarizing film) [provided that on the surface opposite to the pressure-sensitive adhesive layer-laminated side surface, the unsaponified TAC film was all laminated]; the base concentration; the mixed solvent composition; the kind of the pressure-sensitive adhesive solution; and/or the binder composition. Actually, in each of the examples, plural samples, which were equivalent to each other, were produced.

In Table 2, the wording “Substrate” represents the transparent protective film on the anchor-layer-formed-side surface;

“Dry treatment”: the kind of the treatment subjected to the anchor-layer-formed-side surface of the substrate; “Unsaponified TAC”: an optical film made of unsaponified triacetylcellulose (manufactured by Konica Minolta Holdings Inc.);

“Saponified TAC”: an optical film made of saponified triacetylcellulose (manufactured by Konica Minolta Holdings Inc.);

“Acryl”: an optical film made of a lactone-modified acrylic resin,

“ZEONOR”: an optical film made of a norbornene resin (manufactured by Zeon Corp.);

“ARTON”: an optical film made of a norbornene resin (manufactured by JSR Corp.);

“IPA”: isopropyl alcohol,

“Solute 1 [%]” and “Solute 2 [%]”: each the binder content (% by weight) in the anchor-layer-forming coating liquid,

“Dry thickness (nm)”: dry thickness (nm),

“Wet thickness (μm)”: painted coat thickness before dried (μm), and

“Pressure-sensitive adhesive”: the kind of the pressure-sensitive adhesive solution.

About the pressure-sensitive adhesive layer-carrying optical films obtained in each of the examples and the comparative examples, evaluations were made as descried below. The evaluation results are shown in Table 2.

### Anchor Layer Painted-Coat External Appearance:

In each of the examples and the comparative examples, a visual inspection was made about the painted-coat external appearance immediately after the anchor-layer-forming coating liquid was applied and then dried under the predetermined drying conditions. An evaluation criterion therefor is as follows:

AA: Very good painted-coat external appearance without the generation of repellency, paint unevenness nor any contaminants,

A: Good painted-coat external appearance with slight repellency or paint unevenness giving no effect on the viewability of the final product,

B: Painted-coat external appearance with repellency or paint unevenness giving no effect on the viewability and

C: Problem for practical use because of large repellency or paint unevenness, the generation of contaminants, or some other drawback.

### Contaminants in Treatment Over a Long Length:

On a line, the anchor-layer-formed-side surface (the unsaponified-TAC film side surface) of the polarizing film described just above was subjected to an adhesion facilitating treatment (with corona or plasma: 2 kW and 15 m/min in the unit of a width of 1.33 m). Next, a gravure coater was used to paint the anchor-layer-forming coating liquid onto the polarizing film over 3000 m or longer on a line so as to give a predetermined applied coat thickness before dried shown in Table 2. Thereafter, under predetermined drying conditions, the resultant anchor-layer-laminated polarizing film was wound into a long form (in a roll-to-roll manner). In the winding, the painted-coat external appearance after the coating of the anchor layer was checked visually over time. An evaluation criterion therefor is as follows:

AA: Good painted-coat external appearance with the generation of no contaminants in spite of the coating over 3000 m or longer,

A: Generation of slight contaminants within the range of 3000 m in length, but painted-coat external appearance giving no effect on the viewability,

B: Generation of contaminants within the range of 3000 m in length, but painted-coat external appearance giving no effect on the viewability, and

C: Problem for practical use because of the generation of many contaminants within the range of 3000 m in length.

### Evaluation of Adhesion Between Substrate and Pressure-Sensitive Adhesive Layer (Adhesion):

A laminator was used to bond, onto a non-alkali glass plate of 0.7 mm thickness, any one of the pressure-sensitive adhesive layer-carrying polarizing films (420 mm long×320 mm wide) yielded in each of the examples and the comparative examples. Next, this laminate was treated at 50° C. and 5 atm in an autoclave for 15 minutes to cause the two members to adhere closely onto each other (an initial stage). Thereafter, the resultant sample was peeled from the non-alkali glass plate by hand. The adhesion (reworkability) was evaluated in accordance with the following criterion:

AA: Satisfactory peelability with no adhesive residue,

A: Satisfactory peelability with a slight adhesive residue,

B: Peelability with adhesive residues in some regions of the sample, and

C: Adhesive residues in ½ regions or more of the sample.

### Crack Endurance:

A laminator was used to bond, onto each of both the surfaces of a non-alkali glass plate of 0.7 mm thickness, any one of the pressure-sensitive adhesive layer-carrying polarizing films (420 mm long×320 mm wide) yielded in each of the examples and the comparative examples, so as to make the films to have a crossed nicols relation. Next, this laminate was treated at 50° C. and 5 atm in an autoclave for 15 minutes to cause the laminated members to adhere closely onto each other completely. The resultant sample was each treated at 95° C. for 500 hours. As to whether or not cracks were generated, a visual check was then made in accordance with the following evaluating criterion:

AA: No crack,

A: Slight fine cracks giving no effect on the viewability,

B: Fine cracks giving no effect on the viewability in some regions of the sample, and

C: Problem for practical use because of the generation of large cracks or many fine cracks.

### Anchor Layer Thickness Measurement:

In each of the examples and the comparative examples, any one of the pressure-sensitive adhesive layer-carrying optical films on each of which only the anchor layer was provided was dyed with a 2% solution of ruthenium in water for 2 minutes, and then the resultant film was buried into an epoxy resin. A super microtome (Ultracut S, manufactured by Leica) was used to cut the resultant film into a thickness of about 80 nm. Next, a cross section of this slice of the optical film was observed through a transmission electron microscope (H-7650, manufactured by Hitachi. Ltd., accelerating voltage: 100 kV) to measure the thickness of the anchor layer after dried (dry thickness (nm)).

### Surface Resistivity:

A surface resistivity measuring instrument (Hiresta MCP-HT450, manufactured by Mitsubishi Chemical Corp.) was used to measure the surface resistivity of the antistatic layer of any one of the samples of each of the examples.

### Picture Plane Display-Performance:

An IPS mode liquid crystal cell was used which had, on the front side thereof, a glass substrate treated with ITO and had, on the rear side thereof, a glass substrate untreated with ITO. From any one of the samples (optical films) of each of the examples, the release sheet A was peeled, and a pressure-sensitive adhesive layer was bonded to the rear side surface of the present liquid crystal cell. The resultant was put onto a backlight in the state that the pressure-sensitive adhesive layer-bonded surface of this liquid crystal panel was directed upwards. Next, the surface protective film on the surface of the optical film was peeled in the 180° direction at a constant speed of 5 m/minute. The liquid crystal layer was checked about a disturbance thereof. The display-performance of the sample was evaluated by measuring a period required until the disturbance of the liquid crystal layer was returned into the original state.

A: 1 second, or shorter,

B: 5 seconds, or shorter,

C: 1 minute or shorter, and

D: 30 minutes or longer.

### Simplicial Transmittance:

From the center in the width direction of any one of the resultant polarizing plates of the examples, a sample of 50 mm×25 mm size was cut out to set the angle of the absorption axis of the polarizing plate to the long sides thereof to 45°. An integrating sphere type transmittance measuring instrument (DOT-3C, manufactured by Murakami Color Research Laboratory Co., Ltd.) was used to measure the simplicial transmittance Ts (%).

TABLE 2

| | | | | Anchor layer forming conditions | | | | | | | |
|---|---|---|---|---|---|---|---|---|---|---|---|
| | | | | | | | | | | Drying conditions | |
| | | | | | | | | | | | Wet |
| | | | | Composition of anchor-layer-forming | | | | | | | painted |
| | | | Pressure- | coating liquid | | | | | | Dry | coat |
| | | Dry | sensitive | | | | Base | Solute 1 | Solute 2 | thickness | thickness |
| | Substrate | treatment | adhesive | Solvent | Solute 1 | Solute 2 | [%] | [%] | [%] | [nm] | [μm] |
| Example 1 | Unsaponified | Corona | A | Water/IPA = | DENATRON | EPOCROS | 0.4 | 0.22 | 0.18 | 48 | 12 |
| | TAC | | | 65/35 | P-580W | WS-700 | | | | | |
| Example 2 | Unsaponified | Corona | A | Water/IPA = | DENATRON | EPOCROS | 0.4 | 0.22 | 0.16 | 48 | 12 |
| | TAC | | | 70/30 | P-580W | WS-700 | | | | | |
| Example 3 | Unsaponified | Corona | B | Water/IPA = | DENATRON | EPOCROS | 0.4 | 0.22 | 0.18 | 48 | 12 |
| | TAC | | | 70/30 | P-580W | WS-700 | | | | | |
| Example 4 | Unsaponified | Corona | A | water/IPA = | DENATRON | EPOCROS | 0.4 | 0.22 | 0.16 | 48 | 12 |
| | TAC | | | 80/20 | P-580W | WS-700 | | | | | |
| Example 5 | Unsaponified | Corona | A | Water = 100 | DENATRON | EPOCROS | 0.4 | 0.22 | 0.10 | 48 | 12 |
| | TAC | | | | P-580W | WS-700 | | | | | |
| Example 6 | Unsaponified | Plasma | A | Water/IPA = | DENATRON | EPOCROS | 0.4 | 0.22 | 0.18 | 48 | 12 |
| | TAC | | | 65/35 | P-580W | WS-700 | | | | | |
| Example 7 | Unsaponified | None | A | Water/IPA = | DENATRON | EPOCROS | 0.4 | 0.22 | 0.18 | 48 | 12 |
| | TAC | | | 65/35 | P-580W | WS-700 | | | | | |
| Example 8 | Saponified TAC | None | A | Water/IPA = | DENATRON | EPOCROS | 0.4 | 0.22 | 0.18 | 48 | 12 |
| | | | | 65/35 | P-580W | WS-700 | | | | | |
| Example 9 | Acryl | Corona | A | Water/IPA = | DENATRON | EPOCROS | 0.4 | 0.22 | 0.18 | 48 | 12 |
| | | | | 65/35 | P-580W | WS-700 | | | | | |
| Exam- | Acryl | None | A | Water/IPA = | DENATRON | EPOCROS | 0.4 | 0.22 | 0.18 | 48 | 12 |
| ple 10 | | | | 65/35 | P-580W | WS-700 | | | | | |
| Exam- | ZEONOR | Corona | A | Water/IPA = | DENATRON | EPOCROS | 0.4 | 0.22 | 0.18 | 48 | 12 |
| ple 11 | | | | 65/35 | P-580W | WS-700 | | | | | |
| Exam- | ARTON | Corona | A | Water/IPA = | DENATRON | EPOCROS | 0.4 | 0.22 | 0.18 | 48 | 12 |
| ple 12 | | | | 65/35 | P-580W | WS-700 | | | | | |
| Exam- | Unsaponified | Corona | A | Water/IPA = | DENATRON | EPOCROS | 0.6 | 0.33 | 0.27 | 72 | 12 |
| ple 13 | TAC | | | 70/30 | P-580W | WS-700 | | | | | |
| Exam- | Unsaponified | Corona | A | Water/IPA = | DENATRON | EPOCROS | 0.8 | 0.44 | 0.36 | 96 | 12 |
| ple 14 | TAC | | | 70/30 | P-580W | WS-700 | | | | | |
| Exam- | Unsaponified | Corona | A | Water/IPA = | DENATRON | EPOCROS | 1 | 0.55 | 0.45 | 120 | 12 |
| ple 15 | TAC | | | 70/30 | P-580W | WS-700 | | | | | |
| Exam- | Unsaponified | Corona | A | Water/IPA = | DENATRON | EPOCROS | 1.45 | 1 | 0.45 | 175 | 12 |
| ple 16 | TAC | | | 70/30 | P-580W | WS-700 | | | | | |
| Com- | Unsaponified | Corona | A | Water/IPA = | DENATRON | — | 0.4 | 0.22 | 0.18 | 48 | 12 |
| parative | TAC | | | 65/35 | P-580W | | | | | | |
| Exam- | | | | | | | | | | | |
| ple 1 | | | | | | | | | | | |
| Com- | Unsaponified | Corona | A | Water/IPA = | — | EPOCROS | 0.4 | 0.22 | 0.18 | 48 | 12 |
| parative | TAC | | | 65/35 | | WS-700 | | | | | |
| Exam- | | | | | | | | | | | |
| ple 2 | | | | | | | | | | | |
| Com- | Unsaponified | Corona | A | Water/IPA = | DENATRON | EPOCROS | 0.4 | 0.22 | 0.18 | 48 | 12 |
| parative | TAC | | | 55/45 | P-580W | WS-700 | | | | | |
| Exam- | | | | | | | | | | | |
| ple 3 | | | | | | | | | | | |
| Com- | Unsaponified | Corona | A | Water/IPA = | DENATRON | EPOCROS | 0.4 | 0.22 | 0.18 | 48 | 12 |
| parative | TAC | | | 45/55 | P-580W | WS-700 | | | | | |
| Exam- | | | | | | | | | | | |
| ple 4 | | | | | | | | | | | |
| Com- | Unsaponified | Corona | A | Water/IPA = | DENATRON | EPOCROS | 0.4 | 0.22 | 0.18 | 48 | 12 |
| parative | TAC | | | 20/80 | P-580W | WS-700 | | | | | |
| Exam- | | | | | | | | | | | |
| ple 5 | | | | | | | | | | | |

| | Anchor layer forming conditions | | | | Results | | | | | | |
|---|---|---|---|---|---|---|---|---|---|---|---|
| | Drying conditions | | | | | Contaminants | Adhesion | | | | |
| | Drying | | | Period | | in | between | | Picture | Simplicial | |
| | tempera- | Drying | | [s] up | Paintability | treatment | substrate | Surface | plane | transmit- | Crack |
| | ture | period | Drying | to oven | [external | over long | and | resistivity | displaying- | tance | (at |
| | [° C.] | [s] | parameter | processing | appearance] | length | adhesive | [Ω/□] | performance | [%] | 95° C.) |
| Example 1 | 50 | 25 | 1250 | 5 | AA | B | AA | 5 × 10\hat{ }8 | A | 43.6 | AA |
| Example 2 | 50 | 25 | 1250 | 5 | AA | A | AA | 1 × 10\hat{ }8 | A | 43.6 | AA |
| Example 3 | 50 | 25 | 1250 | 5 | AA | A | A | 1 × 10\hat{ }8 | A | 43.6 | AA |
| Example 4 | 50 | 25 | 1250 | 5 | A | A | AA | 1 × 10\hat{ }8 | A | 43.6 | AA |
| Example 5 | 50 | 25 | 1250 | 5 | B | AA | AA | 1 × 10\hat{ }8 | A | 43.6 | AA |
| Example 6 | 50 | 25 | 1250 | 5 | AA | A | AA | 5 × 10\hat{ }8 | A | 43.6 | AA |
| Example 7 | 50 | 25 | 1250 | 5 | B | AA | AA | 5 × 10\hat{ }8 | A | 43.6 | AA |
| Example 8 | 50 | 25 | 1250 | 5 | AA | AA | AA | 5 × 10\hat{ }8 | A | 43.6 | AA |
| Example 9 | 50 | 25 | 1250 | 5 | AA | A | AA | 5 × 10\hat{ }8 | A | 43.6 | AA |
| Exam- | 50 | 25 | 1250 | 5 | A | AA | A | 5 × 10\hat{ }8 | A | 43.6 | AA |
| ple 10 | | | | | | | | | | | |
| Exam- | 50 | 25 | 1250 | 5 | AA | AA | AA | 5 × 10\hat{ }8 | A | 43.6 | AA |
| ple 11 | | | | | | | | | | | |
| Exam- | 50 | 25 | 1250 | 5 | AA | AA | AA | 5 × 10\hat{ }8 | A | 43.6 | AA |
| ple 12 | | | | | | | | | | | |
| Exam- | 50 | 25 | 1250 | 5 | AA | A | AA | 5 × 10\hat{ }7 | A | 43.5 | AA |
| ple 13 | | | | | | | | | | | |
| Exam- | 50 | 25 | 1250 | 5 | AA | A | AA | 1 × 10\hat{ }7 | A | 43.4 | AA |
| ple 14 | | | | | | | | | | | |
| Exam- | 50 | 25 | 1250 | 5 | AA | A | AA | 1 × 10\hat{ }7 | A | 43.3 | AA |
| ple 15 | | | | | | | | | | | |
| Exam- | 50 | 25 | 1250 | 5 | AA | A | AA | 1 × 10\hat{ }7 | A | 42.9 | AA |
| ple 16 | | | | | | | | | | | |
| Com- | 50 | 25 | 1250 | 5 | C | B | A | 5 × 10\hat{ }8 | A | 43.6 | AA |
| parative | | | | | | | | | | | |
| Exam- | | | | | | | | | | | |
| ple 1 | | | | | | | | | | | |
| Com- | 50 | 25 | 1250 | 5 | AA | AA | A | 1 × 10\hat{ }14 or | D | 43.7 | AA |
| parative | | | | | | | | more | | | |
| Exam- | | | | | | | | | | | |
| ple 2 | | | | | | | | | | | |
| Com- | 50 | 25 | 1250 | 5 | AA | C | AA | 1 × 10\hat{ }9 | A | 43.6 | AA |
| parative | | | | | | | | | | | |
| Exam- | | | | | | | | | | | |
| ple 3 | | | | | | | | | | | |
| Com- | 50 | 25 | 1250 | 5 | AA | C | AA | 5 × 10\hat{ }9 | B | 43.6 | AA |
| parative | | | | | | | | | | | |
| Exam- | | | | | | | | | | | |
| ple 4 | | | | | | | | | | | |
| Com- | 50 | 25 | 1250 | 5 | AA | A | AA | 1 × 10\hat{ }10 | C | 43.6 | AA |
| parative | | | | | | | | | | | |
| Exam- | | | | | | | | | | | |
| ple 5 | | | | | | | | | | | |

What is claimed is:

1. A coating liquid for forming an anchor layer interposed between an optical film and a pressure-sensitive adhesive layer, comprising
a polythiophene based polymer, a polyoxyalkylene-group-containing polymer, and a mixed solvent comprising 65 to 100% by weight of water and 0 to 35% by weight of an alcohol.

2. The anchor-layer-forming coating liquid according to claim 1, further comprising a polyurethane resin based binder.

3. The anchor-layer-forming coating liquid according to claim 2, wherein the polythiophene based polymer is comprised in a proportion of 0.005 to 5% by weight, the polyoxyalkylene-group-containing polymer in a proportion of 0.005 to 5% by weight, and the polyurethane resin based binder in a proportion of 0.005 to 5% by weight.

4. A pressure-sensitive adhesive layer-carrying optical film with a pressure-sensitive adhesive layer laminated over at least one surface of the optical film with an anchor layer interposed therebetween,
wherein the anchor layer is a layer obtained by coating and drying the anchor-layer-forming coating liquid according to claim 1 over the optical film, and the anchor layer alone shows a transmittance reduction of 1% or less.

5. The pressure-sensitive adhesive layer-carrying optical film according to claim 4, wherein the optical film is a film obtained by subjecting an anchor-layer-formed-side surface of the film to an adhesion facilitating treatment.

6. The pressure-sensitive adhesive layer-carrying optical film according to claim 4, wherein the anchor-layer-formed-side surface of the optical film comprises unsaponified triacetylcellulose.

7. The pressure-sensitive adhesive layer-carrying optical film according to claim 4, which is a pressure-sensitive adhesive layer-carrying polarizing film.

8. A method for producing a pressure-sensitive adhesive layer-carrying optical film with a pressure-sensitive adhesive layer laminated over at least one surface of the optical film with an anchor layer interposed therebetween, comprising, before the step of forming the anchor layer, at least,
an adhesion facilitating treatment step of subjecting the anchor-layer-formed side surface of the optical film to an adhesion facilitating treatment, and
an application step of applying the anchor-layer-forming coating liquid according to claim 1 onto the adhesion facilitating treatment surface of the optical film,
wherein the anchor layer alone shows a transmittance reduction of 1% or less.

9. The method for producing the pressure-sensitive adhesive layer-carrying optical film according to claim 8, wherein the anchor-layer-formed-side surface of the optical film comprises unsaponified triacetylcellulose.

10. The method for producing the pressure-sensitive adhesive layer-carrying optical film according to claim 8, wherein the application step is followed by an anchor layer forming step comprising drying the coating liquid under conditions satisfying both of the following requirements: (1) the drying temperature T is between 40° C. and 70° C.; and (2) the value (T×H) obtained by multiplying the drying temperature T (° C.) by the drying time H (seconds) satisfies the relation 400≦(T×H)≦4,000 so that the mixed solvent is removed when the anchor layer is formed.

11. The method for producing the pressure-sensitive adhesive layer-carrying optical film according to claim 10, wherein there is a time period of at most 30 seconds between applying the anchor layer-forming coating liquid to the optical film and starting the drying.

12. The method for producing the pressure-sensitive adhesive layer-carrying optical film according to claim 8, wherein the pressure-sensitive adhesive layer-carrying optical film is a pressure-sensitive adhesive layer-carrying polarizing film.

13. An image display device, wherein the pressure-sensitive adhesive layer-carrying optical film according to claim 4 is used.
